(19) United States
(12) Patent Application Publication
(10) Pub. No.: US 2024/0267312 A1
(43) Pub. Date: Aug. 8, 2024

(54) METHOD AND SYSTEM FOR PROVIDING A VIRTUAL STUDIO ENVIRONMENT OVER THE INTERNET

(71) Applicant: SYNCDNA CANADA INC., Kitchener (CA)

(72) Inventors: John Christopher BAILEY, Kitchener (CA); Dominic Antonio CASTRO, Kitchener (CA); Gary Steven LUCHS, Kitchener (CA); Martin DUARTE ARREDONDO, Kitchener (CA); Gregory Mark SECORD, Kitchener (CA); Arne WILHELMSEN, Kitchener (CA)

(21) Appl. No.: 18/562,975

(22) PCT Filed: Mar. 30, 2023
(86) PCT No.: PCT/CA2023/050426

§ 371 Date: Nov. 21, 2023

Related U.S. Application Data
(60) Provisional application No. 63/325,418, filed on Mar. 30, 2022.

(51) Int. Cl. H04L 43/0864; G10H 1/00

(52) U.S. Cl. CPC H04L 43/0864; G10H 1/0058; G10H 2240/175

(57) ABSTRACT

The disclosure is directed at a method and system for synchronizing inputs transmitted over the Internet from a set of devices. The disclosure transmits a set of individual timing packets to each of the set of devices and, after receiving a set of return individual timing packets, determines a round trip time for each of the set of return individual timing packets. The round trip time is then used to calculate a timeslot offset for each of the devices which is then used to synchronize the transmission of data between the disclosure and the set of devices.

### CROSS-REFERENCE TO OTHER APPLICATIONS

The current disclosure claims priority from U.S. Provisional Patent Application No. 63/325,418 filed Mar. 30, 2022 which is hereby incorporated by reference.

### FIELD

The disclosure is generally directed at the music industry, and more specifically, at a method and system for providing a virtual studio environment over the Internet.

### BACKGROUND

In the past, for songs to be recorded, musicians would typically record their individual parts or they would collectively record together at a musical recording studio. Usually, this resulted in all of the musicians needing to be there at the same time in order to record together. The individual parts are then combined to form a single musical track. In more recent days, musicians can record their individual parts and then store them on digital mediums for transmission to someone who can then combine the parts into the musical track.

The Internet is not designed for precise synchronization, but rather built on best-effort data traffic whereby it is difficult to maintain synchronization between different collaborator (such as artists, musicians or producers) connections. One main challenge with Internet collaboration is the elastic variable time (flux of latency) that exists across multiple remote locations during the transmission of multiple audio and video files in real-time. Sample-accurate synchronization between audio files and frame-accurate sync between video files is a requirement in any music and film production environment.

Equally, a stable low-latency experience for musical performers is also required to enable a reasonable collaboration and interplay between the musicians during their performance. Currently, there are physical limitations that make it tough or impossible to create a low-latency transmission across public Internet connections beyond a specific network, or physical, radius.

While use of streaming and video conferencing on the Internet may be contemplated, this solution also lacks one aspect of musical fun which is a high-quality, synchronous musical collaboration. While under the right conditions (such as within a radius of about 250 miles), the Internet may be used for ultra-low latency, uncompressed sound transmission but the transmission is still subject to the elasticity and unreliability of the Internet. As such, the best results only occur when musicians are all connected to a single Internet Service Provider's (ISP's) point of presence (POP) thereby avoiding Internet exchanges. However, this may not be possible as musicians are located worldwide.

Currently, to connect musicians together over the Internet to facilitate performance, many compromises are made in order to achieve the lowest latency. For example, each musician may be assigned a minimum or low number of channels (often just mono) to achieve acceptable latency. Conversely, when capturing instruments for the purpose of recording and sonic entertainment, more microphone channels are often required, especially when capturing ambience as well. For that reason, a hybrid approach is necessary to both connect musicians for the purpose of the interaction, but more importantly, for the resulting sound to be sonically pleasing, entertaining, and accurate.

A further challenge is that, since it is nearly impossible to precisely predict when audio and video data streams might arrive at any given location, it is likely that audio dropouts will occur when network conditions temporarily degrade. This makes it extremely frustrating for musicians located in physically remote locations to collaborate with other musicians without experiencing a high degree of unreliability. When creative collaborators or musicians are provided access to high-performance broadcaster-level networks, more options are available, however, a session is only as good as the worst Internet connection. Achieving high-level collaboration over the Internet is therefore a challenge.

Therefore, there is provided a method and system for a virtual studio environment over the Internet that overcomes at least some disadvantages of current solutions.

### SUMMARY

In one embodiment, the disclosure is directed at a method and system for time-locked multi-client (or collaborator) audio/video synchronization. The disclosure may be used for music recording, broadcast and/or film post production collaboration over a network, such as the Internet. In another embodiment, the disclosure is directed at a real-time, sample-accurate, high-resolution audio recording and collaboration system and method for providing a virtual studio environment for collaborators (such as, but not limited to, producers, artists, film post producers, and broadcasters) to create music and collaborative content from anywhere in the world. By defining the existing time properties of the Internet, the disclosure may provide improved audio/video transmission. The disclosure uses a multi-tier approach for latency optimization including fixed time-slot offsets associated with a common system clock.

In another embodiment, the disclosure supports bidirectional, one-to-one, and one-to-many-to-one simultaneous multi-track audio and video transmission, enabling relative “real-time” musical recording and collaboration over the Internet.

In one aspect of the disclosure there is provided a method for synchronizing inputs received over the Internet from a set of a collaborator devices including transmitting a set of individual timing packets to each of the set of collaborator devices; determining a round trip time (RTT) value for each of the set of collaborator devices based on the set of individual timing packets; calculating a collaborator radius value for each of the set of collaborator devices based on the RTT value; and calculating a timeslot offset value based on the collaborator radius value for each of the set of collaborator devices.

In another aspect, the method further includes applying the timeslot offset to a transmission of data with each of the collaborator devices. In yet another aspect, applying the timeslot offset occurs after an action is taken to start timeline transport. In a further aspect, the method further includes calculating an updated timeslot offset value by transmitting an updated set of individual timing packets to each of the set of collaborator devices; determining an updated RTT value for each of the set of collaborator devices based on the updated set of individual timing packets; calculating an updated collaborator radius value for each of the set of collaborator devices based on the updated RTT value; and calculating the updated timeslot offset value based on the updated collaborator radius value for each of the set of collaborator devices.

In yet another aspect, determining a RTT value includes determining a time period between transmitting one of the set of individual time packets to a selected collaborator device and receiving a returned individual time packet, from the selected collaborator device; wherein the returned individual time packet is based on the one of the set of individual time packets. In another aspect, calculating a timeslot offset value based on the collaborator radius value for each of the set of collaborator devices includes adding a first collaborator radius value to a second collaborator radius value to generate; and applying a buffer value to a sum of the first collaborator radius value and the second collaborator radius value. In yet a further aspect, the first collaborator radius value is selected as a highest collaborator radius value within a first grouping of collaborator devices. In another aspect, the second collaborator radius value is selected as a highest collaborator radius value within a second grouping of collaborator devices.

In yet another aspect, the set of collaborator devices includes at least one of a producer digital audio workstation, a non-linear video editing system, a musician collaborator device, an artist collaborator device or a guest collaborator device. In another aspect, transmitting a set of individual timing packets to each of the set of collaborator devices includes transmitting the set of individual timing packets to an application associated with the system that is executing on the collaborator device. In yet a further aspect, the set of individual timing packets is transmitted via a clock system module. In another aspect, before, transmitting a set of individual timing packets to each of the set of collaborator devices, the method including authenticating each of the set of collaborator devices.

In another aspect of the disclosure, there is provided a non-transitory computer readable medium having instructions stored thereon that, when executed, cause at least one computer system to transmit a set of individual timing packets to each of the set of collaborator devices; determine a round trip time (RTT) value for each of the set of collaborator devices based on the set of individual timing packets; calculate a collaborator radius value for each of the set of collaborator devices based on the RTT value; and calculate a timeslot offset value based on the collaborator radius value for each of the set of collaborator devices.

### BRIEF DESCRIPTION OF THE DRAWINGS

Embodiments of the present disclosure will now be described, by way of example only, with reference to the attached Figures.

FIG. 1 is a schematic diagram of a virtual studio environment;

FIG. 2 is a schematic diagram of a system for providing a virtual studio environment over a network;

FIG. 3a is a flowchart outlining one method for providing a virtual studio environment over a network;

FIG. 3b is a flowchart outlining another method for providing a virtual studio environment over a network;

FIGS. 3c and 3d show a flowchart outlining another embodiment of a method for providing a virtual studio environment over a network;

FIG. 4 is a flowchart showing a method of synchronizing inputs from multiple collaborators;

FIG. 5a is a schematic diagram of a system for receiving asynchronous inputs from multiple collaborators;

FIG. 5b is a schematic diagram of a system for synchronizing inputs from multiple collaborators;

FIG. 6 is a schematic diagram of a digital audio workstation;

FIG. 7 is a schematic diagram of a collaborator device;

FIGS. 8a to 8d are directed at a schematic diagram of one embodiment of a system architecture;

FIGS. 9a to 9f are directed at a schematic diagram of another embodiment of a system architecture;

FIG. 10 is an example of a clock client; and

FIGS. 11a to 11c are examples of round-trip-time (RTT) calculations.

### DETAILED DESCRIPTION

The disclosure is directed at a method and system for providing a virtual studio environment over the Internet. In one embodiment, the disclosure is directed at a method and system for synchronizing inputs that are transmitted over the Internet (either public or private) to a central location or server. In another embodiment, the disclosure receives a set of inputs (such as instrumental or vocal tracks) in real-time and then processes the inputs to co-ordinate the tracks. For example, the inputs are processed so that when they are layered on top of each other, all of the tracks are synchronized. In one embodiment, this processing includes determining individual timing packet return times that are used to synchronize the inputs.

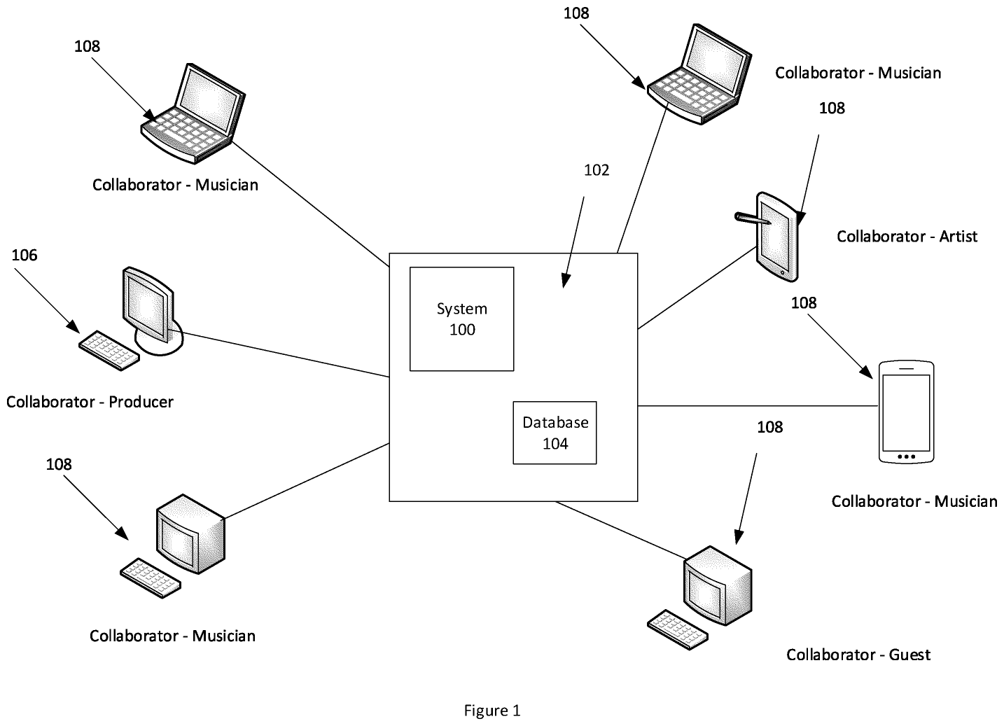

Turning to FIG. 1, a schematic diagram of the system of the disclosure within an operating environment, which may be seen as a virtual studio environment, is shown. The system 100 for providing a virtual studio environment over the Internet is stored within, and executed by, a server 102 or the like. The server 102 may be seen as a central processing unit (CPU) or may be a network cloud backend services component that is connected to a network, such as the Internet. In other embodiments, the system 100 may include its own processor for execution of the method of providing the virtual studio environment over the Internet. The system 100 may also be connected with a database 104 that is located within server 102 or may be remote from the server in other embodiments.

The system 100 is in communication with a set of collaborators or clients (represented in FIG. 1 by collaborator devices 106 or 108) to receive inputs, such as, but not limited to, musical instrumental or voice tracks that the collaborators are performing live or feeding pre-recorded audio into the system concurrently, or messages from one or more collaborators. Examples of collaborators may include, but are not limited to, musicians, instrumentalists, artists, vocalists, directors, filmmakers, broadcasters, or producers. In the description, use of the term collaborators, clients and musicians should be seen as interchangeable. The system also provides the functionality to synchronize the inputs from the set of musicians such as by transmitting and receiving individual timing packets and the processing the received individual timing packets. This will be described in more detail below.

In the current embodiment, collaborators accessing the system 100 may include a producer 106 seen as a workstation client-producer with digital audio workstation (DAW) that, in some embodiments, controls aspects of the system 100 by providing input or instructions to the system 100 to perform certain actions. For example, the producer may instruct the system to communicate with other non-producer collaborators (represented as collaborator devices 108) who may be invited to participate in the virtual studio environment created by the system. As discussed above, the other or non-producer collaborators may be artists, musicians or guests. Collaborator devices 108 may include, but are not limited to, a laptop, a tablet or smart tablet, a smartphone or a user workstation desktop, a Mac™ and the like. In other embodiments, the disclosure may be used in other environments, such as, but not limited to, security or gaming environments. Other examples of collaborator devices may include non-linear video editing software and hardware suites, audio Interfaces including microphone preamplifiers and/or instrument inputs, audio effect processing equipment connected to a network; digital audio mixers, such as used in live performances, wireless Headphones (Bluetooth/WiFi, etc.), media display devices such as smart TVs or Smart DVD/Blu-ray players, closed network intranets, security monitoring devices and related systems, systems to synchronize monitor and track sensors in IoT (Internet of Things), closed circuit television and radio synchronization devices and broadcast systems for live entertainment, sporting events, live news, servers in a network or data centre, security monitoring devices and related systems, sensors for IoT (Internet of Things) devices, closed circuit television and radio systems for media and security, broadcast systems for live entertainment, sporting events, live news, including satellite transmission and microphones that send remote signals via the internet or Bluetooth, Apple TV, Amazon firestick or other internet delivery devices for media, karaoke machines that use the internet for to support streaming media, or multiple participants, Nintendo, Sony Playstation, Microsoft Xbox and other gaming consoles, and/or smart speakers, multiple speaker systems that utilize network connections and the like. Communication and connection between the system 100 and the collaborator devices 106 or 108 will be via known communication protocols over the Internet.

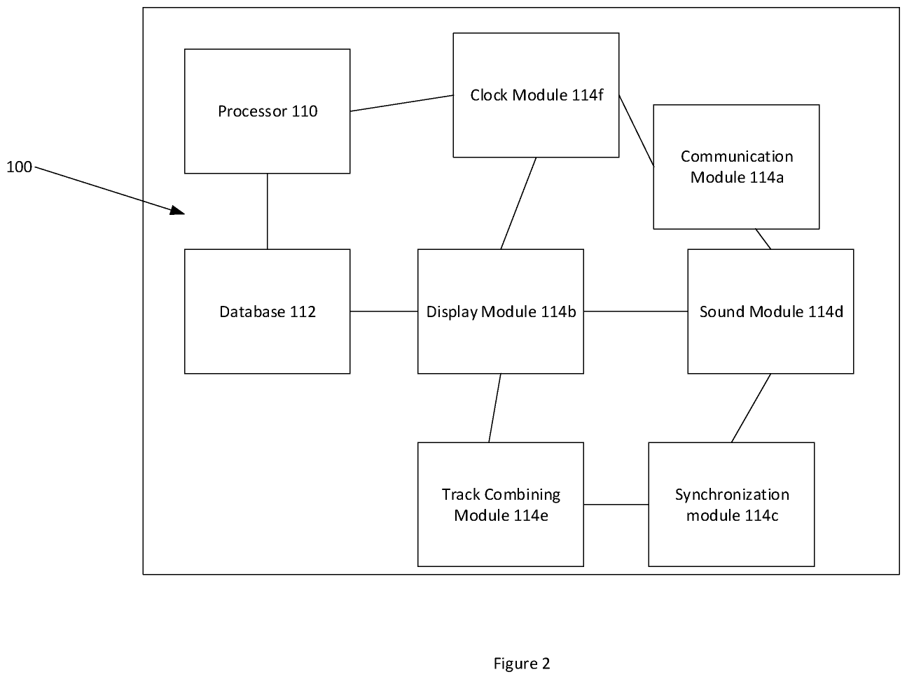

Turning to FIG. 2, a schematic diagram of the system for providing a virtual studio environment over the Internet is shown. The system 100 includes a processor, or processing unit, 110, and a database 112 for storing any inputs (or data) that are received. The database 112 may also store any outputs that are generated via the processing of the inputs.

The system 100 further includes a set of modules 114 for providing the virtual studio environment. These modules may also be implemented via software, hardware, firmware or a combination of software, hardware and firmware.

In the current embodiment, the set of modules 114 includes a communication module 114a that enables the system 100 to communicate with the collaborator devices 106 or 108 to receive and transmit data such as, but not limited to, music tracks or messages requesting the collaborator or musician to record or re-record a section of the music track. The set of modules 114 may also include a display module 114b that generates images or display that may be transmitted by the system 100 to the collaborator devices 106 or 108 for display on those devices.

The set of modules 114 further includes a synchronizing module 114c for synchronizing the inputs received from the set of collaborator devices 108. In one embodiment, the synchronizing module 114c synchronizes the inputs by calculating a round trip time (RTT) between the system 100 and the individual collaborator devices 108, such as by sending an individual timing packet as will be described in more detail below. The synchronizing module 114c may also provide the functionality of sample-accurate remote recording and synchronization of multiple audio and video file transmissions over Internet connections.

In some embodiments, the synchronization module 114c may determine a lag between the system and the individual collaborators or collaborator devices interacting with the system in order to coordinate the different lags such that collaborator inputs are synchronized for the musical session. In one embodiment, the synchronization module 114c transmits an individual timing packet to each of the collaborator devices and then receives a return timing packet from each collaborator device. The module 114c then processes the return timing packets to synchronize the inputs from each of the collaborator devices. In another embodiment, during the initial handshake period with each collaborator device, the system performs an initial high-intensity round-trip timing packet calculation (approx. 50 pings/sec) for each collaborator device and then calculates an average RTT based on the timing packet calculations. The module 114c also provides the functionality to perform a speed test with each collaborator device to determine if a threshold or optimal bandwidth can be maintained. Once initial values are set, the module 114c continues to calculate a rolling average for each collaborator device based on RTT. In other words, the process of synchronizing inputs continues during the whole session. The synchronization module 114c may also include a learning algorithm for generating an accurate calculation of a system clock/PTP correction variable.

The set of modules 114 may further include a sound module 114d which may process the individual inputs to remove any extraneous inputs or sounds. For example, the sound module 114d may remove any background sounds that are accidently included within an input track provided by a collaborator or musician (instrumental or vocal). The set of modules 114 may further include a track combining module 114e that may combine the synchronized tracks into a single musical track.

The set of modules 114 may further include a clock module 114f that provides a standard clock and maintains a reference clock against which all the inputs (via the collaborators or collaborator devices) are timed in order to synchronize the inputs from the collaborators. In some embodiments, the clock module 114f may calculate the RTT for each musician (collaborator) and may also calculate a lob delay for each musician that is based on the RTT determined for each musician (collaborator). In other embodiments, the clock module 114f may perform at least some of the functionality of the synchronization module or perform the RTT and lob delay calculations along with the synchronization module 114c.

Although only some connections between different components of the system 100 are shown, it is understood that the processor 110 may communicate with each of the modules 114 and that each of the modules may also communicate with any other module. Both the processor 110 and the set of modules 114 may communicate or access the database 112 to retrieve data from or store data to the database 112.

Although not shown, the set of modules 114 may further include a collaborator authorization module that enables collaborators to connect to the system and may also authenticate collaborators to confirm that the collaborator is allowed to access the system or that the collaborator has an account with the system. The set of modules 114 may also include a collaborator database module or component that provides metadata, or attributes, to other modules 114 within the system so that the other modules 114 may perform their functionality. Examples or attributes include, but are not limited to, a community profile, music track inputs, music track templates and the like. The set of modules 114 may further include modules, such as, but not limited to, a service module or component, a project service module or component and/or a session service module or component that provide different functionalities for managing a studio session such as with respect to permissions to monitor the studio session whereby collaborators are only provided access that has been previously permitted.

The set of modules 114 may also include a meeting system module or component that provides the functionality of enabling all collaborators, once authenticated by the authorization module, to be admitted into an audio/video conference for the studio session. In some cases, the video stack is executed within the system's cloud services, and in others, it may be executed on a third party stack. The system may also include a configuration/messaging module that provides the functionality of inter-application messaging, configuration services and communication management between the session service and authenticated collaborators (musicians and producer) with respect to timeline transport commands (“stop”, “play”, “record”, etc.), application mode changes, shared controls and/or timeline status messages.

The set of modules may further include a chuck service module or component that interacts with a group of publisher/subscriber database broker clusters to manage the different types of data in the system. Different technologies such as, but not limited to, SQL/MongoDB, Pub/Sub Messaging-oriented Middleware such as Redis, ActiveMQ, Kafka and/or Akka are contemplated.

In one embodiment, for real-time audio, each collaborator device writes to a single time-series database, which is initially stored locally on the collaborator device. When recording, the collaborator breaks the data stream into chunks, which are inserted into a topic document in binary form, along with metadata markings such as session ID, client ID, channel ID, precision timestamp and cryptographic metadata/authentication/JWT. In other embodiments, in the background, each of these “documents” (chunks) are replicated to the server-based broker cluster and then data is pulled from the subscriber path, assembled in sequence, and played out of a MediaServer component using the timestamps and segment ID numbers to reassemble the audio stream in sample-accurate synch with the DAW timeline (with appropriate offsets).

In one embodiment, the system supports bidirectional, one-to-one and/or one-to-many-to-one simultaneous multi-track audio and video transmission, enabling relative “real-time” musical recording and collaboration over the Internet.

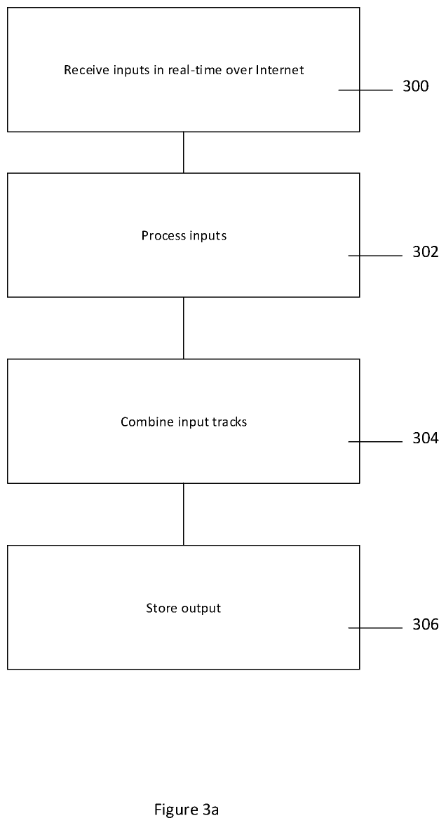

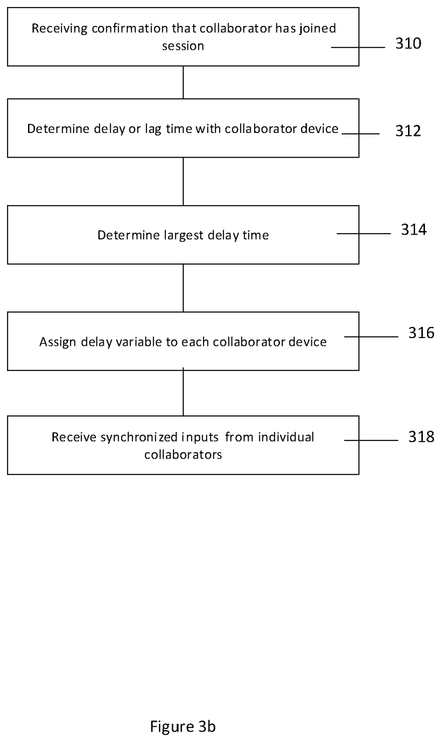

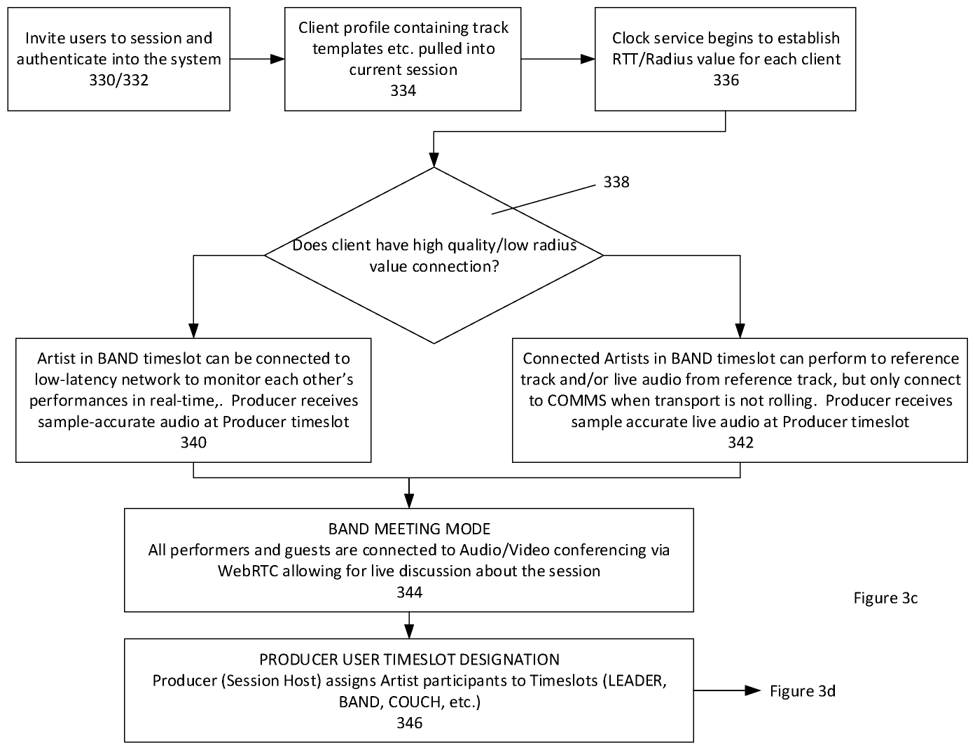

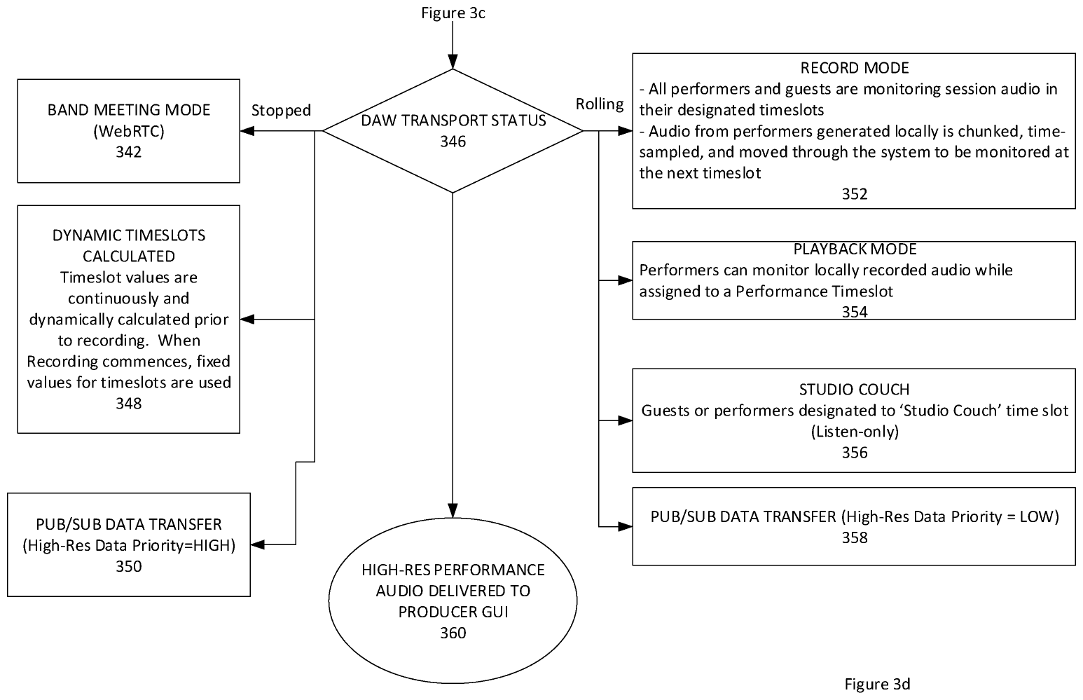

Turning to FIG. 3a, a flowchart outlining a method of providing a virtual studio environment over the Internet is shown.

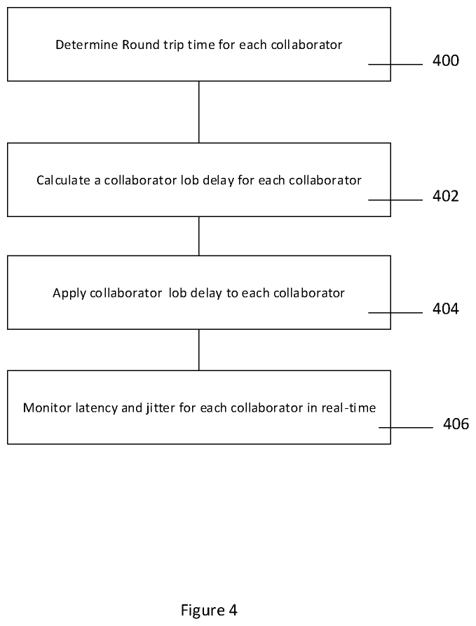

Initially, a set of inputs (which may be seen as individual musical and/or voice tracks) are received in real-time over the Internet (300) such as from collaborator devices. These inputs may be either audio, video or a combination of audio and visual. The inputs may also be in the form of a return timing packet in response to the transmission of an individual timing packet from the system to each of the collaborator devices. The inputs are then processed (302) to determine an amount of lag between the system and the individual collaborator devices. This may be seen as a collaborator radius value. The collaborator radius value can then be used to calculate a timeslot value or timeslot offset that may be used for the synchronization of the transmission of data between the system and the different collaborators or possibly between the collaborators themselves. This is typically based on the network connection that each collaborator is using in comparison with the network connection for the system. In one embodiment, the inputs may be processed to synchronize the inputs such that when they are combined, the resulting output does not include delays between the individual tracks. One method of processing inputs is shown in FIG. 4.

After processing the inputs to synchronize the input tracks, the system then combines the input tracks (304) to generate an output of the combined tracks. In some embodiments, this includes the application of the timeslot values for each collaborator whereby each input is synchronized within its timeslot based on a radius value and a buffer value. The output may be seen as a studio recording or may represent the studio environment that the collaborators are performing within. The output can then be stored, recorded and/or transmitted to an external party (306).

Turning to FIG. 3b, a flowchart outlining another method of providing a virtual studio environment is shown.

Initially, after receiving confirmation or confirming that a collaborator has joined a session (310), the system can then determine a delay or lag time, or transmission delay time, with each collaborator device and the system (312) using individual timing packets as will be described below. In some embodiments, the determination in (312) may be the same as some or all of the input processing (302) of FIG. 3a.

After determining the transmission delay time between the system and each of the collaborators (or collaborator devices), the system determines which collaborator has the largest transmission delay time (314). The system then determines how to apply the largest transmission delay time to the transmissions from the other collaborators. In other words, the system assigns a timeslot variable or value to each of the collaborator devices (316).

After assigning the timeslot variable or value, the collaborators can begin to transmit data or data chunks (such as in the form of a musical input or track) to the system which is received by the system (318) when instructed or signaled. The assignment or application of the timeslot variable or value results in the transmission from each of the collaborators to be synchronized. In some embodiments, as the musicians or collaborators continue to transmit data, the system may continually perform (312) to (316) such that the inputs continue to be synchronized despite the unreliability of Internet or network connections.

Turning to FIGS. 3c and 3d, a flowchart outlining another method of providing a virtual studio environment over the Internet is shown.

Initially, the system issues a session invitation (330). The session invitation is transmitted to collaborators that have been selected for the musical session or musical studio event. In one embodiment, an authenticated collaborator (such as a producer) may engage with the system to log into their account. The system then receives payload from a payment authority confirming that the account is current and/or valid. The account holder can then create or initiate a producer session (host), and generate invitation links for desired collaborators as either an Artist or a Guest. The invitation links are then transmitted to the selected collaborators. Invited collaborators receive an email from the system that prompts the invited collaborator to download an application onto their collaborator device. In other embodiments, the system may push software to the collaborator device. The collaborator can then create an account if they have not already done so. Invited collaborators who have accounts in the system are then able to log in and be authenticated by the system (332). After authentication, the collaborator may join the session at the predetermined date and time. In one embodiment, the database may be divided into different structures, such as, but not limited to, User/Organization/Project/Session to store different information that is supplied to the database.

The system may then generate a collaborator profile for each of the invited collaborators with track templates pulled into the producer session (334). In some embodiments, prior to the scheduled session, the producer or host is able to pull track template data into their session setup from invited collaborators (artists) that have previously stored input setups and track templates in the database. This information may be stored in the database and associated with a collaborator's account. The input setups from artists may contain information such as, but not limited to, “01 Piano Inside Low, 02 Piano Inside High, 03 Piano Room Ambience Low, 04 Piano Room Ambience High, 05 Fender Rhodes Left, 06 Fender Rhodes Right, 07 Nord Synth Left, 08 Nord Synth Right”. This information allows the producer to completely configure the session in advance so that work can begin immediately upon commencing the session.

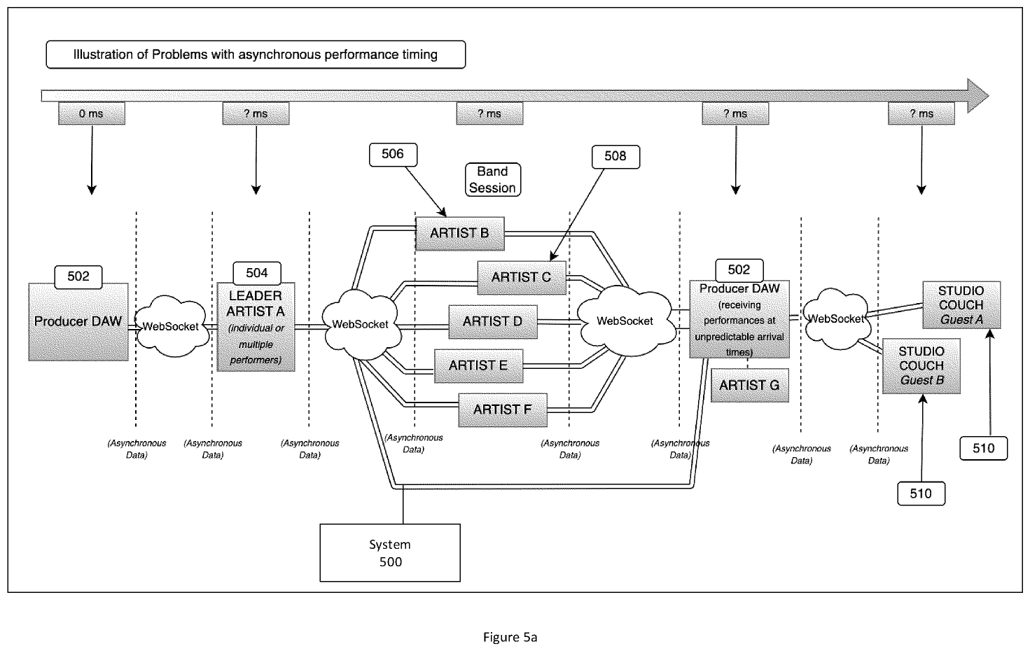

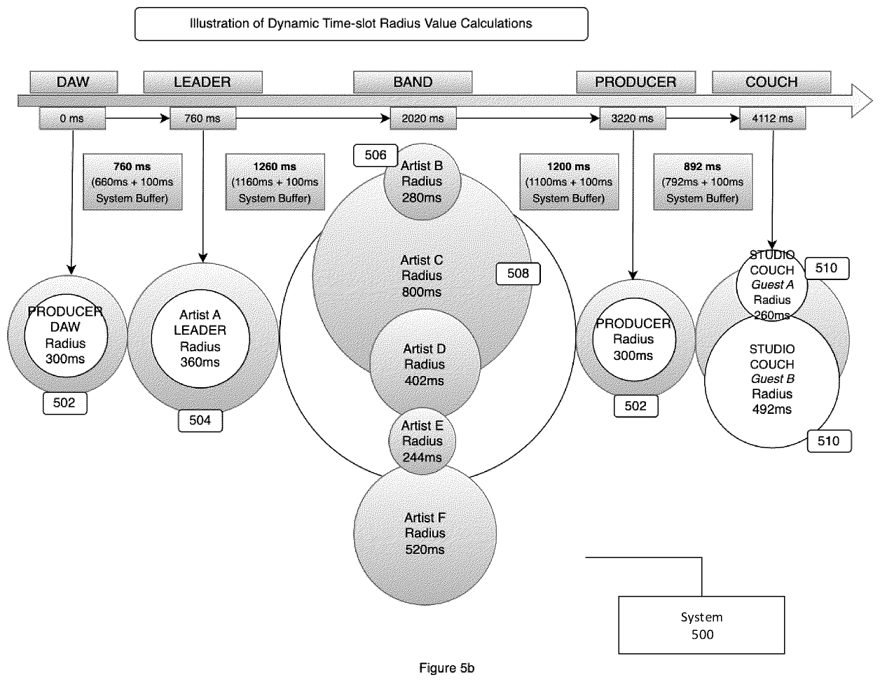

The system then initiates a clock/connection service to establish RTT/radius (336). In one embodiment, as each collaborator (artist or guest) connects to the system (or session), the system starts and begins to calculate connection characteristics such as, but not limited to, average RTT, jitter, and other metrics to establish a local clock offset value for each collaborator and a collaborator radius or RTT value (typically measured in milliseconds/samples). The collaborator radius value for each collaborator may be published into a session document (such as stored in the database) and updated regularly. The system then determines which connected collaborators has the highest collaborator radius value, and sets timeslot table values and, if necessary, audio/video chunk sizes accordingly while adding appropriate margins. One example of how a timeslot value can be calculated is discussed below with respect to FIG. 5b. With respect to the audio/video chunk sizes, the chunks sizes may be dynamically selected based on the timeslot value for a collaborator. If the radius value (determined in 336) for each is collaborator low, a smaller chunk size may be selected. If the radius value for each collaborator is a high value, larger chunk size may be increased to improve system performance. The collaborator radius value may represent the physical distance between the server 100 or system 102 and the collaborator device 108. Each collaborator is assigned a collaborator radius parameter that is updated with low granularity (such as every 30 seconds) based on ongoing calculations by the system. Ongoing calculations are performed in order to continuously monitor the lag time between a collaborator and the system in order to maintain on-going synchronicity between the collaborators and the system. In other words, the system continues to transmit individual timing packets (such as in the form of updated individual timing packets) to determine an updated radius value that can be used to calculate an updated timeslot offset value such that any changes in a network connection can be identified by continuously updating the timeslot offset values.

The system then determines if an individual connected collaborator has a high-quality, low-latency connection (338). In one embodiment, the system component makes a determination if a connected collaborator has a high-quality connection or, in other words, a low radius value. If the collaborator has a high-quality connection, the system, via a graphical user interface (such as created by the display module), prompts the collaborator to decide if they would like to connect to a low-latency network such as via JackTrip, Jamulus, SyncSpace and the like.

If the system determines that the collaborator has a high-quality, low-latency connection, the system then places the collaborator in a band timeslot (340) so that the collaborator can be interconnected and be able to monitor other performances or tracks from other collaborators in real-time. This may be achieved by enabling a communication channel within their collaborator device to be used to provide a live, real-time monitor of the other performers or collaborators that have been assigned to the band timeslot.

If the system determines that the collaborator does not have a high-quality, low-latency connection, the system does not connect or assign the collaborator to the low-latency COMMs bus (342). In (342), if the collaborator's connection does not qualify them to connect to a low-latency network, a communication channel within the collaborator device may be used to provide the collaborator with only audio when the timeline transport is stopped, but otherwise will mute while the timeline transport is in Rolling Mode.

After assigning all of the collaborators based on their connection, the system then initiates a band meeting mode (344). In one embodiment, all of the collaborators (producer, musicians, artists, guests) of the session are joined into an audio/video meeting. The system then combines multiple web RTC backend systems (e.g. SFU/MCU) (based on how the collaborator devices are connected to the system) and uses them, simultaneously, in specific timeslots within any given session. By doing so, this enables non-performing collaborators in a subsequent timeslot or timeslots to receive and view high-resolution video from users in a prior performing timeslot, while minimizing or reducing bandwidth and computer usage thereby improving system performance.

The system then creates a producer timeslot designation (346) where collaborators can be designated (by the producer or the system) as a “remote artist” or “local artist”. When the timeline transport is engaged in Rolling mode, the system then uses fixed timeslot values (348). In one embodiment, a sample-based producer DAW timeline position is connected to the system via a connection from DAW Plug-ins and a MediaServer module (within the collaborator device 106) and a high-precision timeline position is then reduced to a lower level of granularity and used in a middleware module and/or a front-end GUI module.

If the DAW timeline transport is stopped, it is assumed that the system is in the band meeting mode (342) whereby dynamic timeslots (348) are calculated. The dynamic timeslots are continuously and dynamically calculated in the background, regardless of DAW timeline transport status (346). A timeslot may be seen as a time period in which an input is delayed from being played by the system based on collaborator radius values in order to synchronize the inputs from each collaborator device. A width of time between any of the timeslots can be wider or narrower, based on the group of connected collaborators assembled in that particular timeslot assignment, and is adjusted dynamically throughout the session. This allows the unreliability of an Internet connection to be managed and to maintain synchronization between the collaborators during the session. Each time the DAW timeline transport is rolling—and the MediaServer rolls with it, the system uses the timeslot values and chunk size values from the session database. These settings are fixed until the next time the timeline transport is stopped, although calculations continue as a background process while rolling.

When calculating the dynamic timeslots (348), a background publisher/subscriber high-resolution data transfer takes high priority (350). If the DAW timeline transport is rolling, the system can be in record mode, or playback mode whereby the background publisher/subscriber high-resolution data transfer gets low priority (350).

In a record mode (352), all collaborators are monitoring session audio in their designated timeslots whereby audio from record-enabled collaborators generated locally is chunked, time-stamped, and moved through the backend system to be monitored at the next time slot. In a playback mode (354), collaborators can monitor locally recorded audio while assigned to a performance time slot and have access to monitoring effects with controls shared with the producer. Locally-stored reference audio tracks, as well as locally-recorded audio can be controlled with a GUI mixer.

In a studio couch mode (356), collaborators, if designated to the studio couch listening timeslot can monitor audio from the producer via a live transmission (Tx) plug-in. The studio couch can also be used as a source endpoint for live streaming feeds and/or broadcast.

For a publisher/subscriber data transfer (low-priority) (360), when the timeline transport mode is rolling, background publisher/subscriber data transfer for high-resolution data is set to a low priority. Alternatively, high-resolution performance audio may be delivered (360) whereby, if network conditions are good, high-resolution performance audio is delivered concurrently with low-resolution performance audio and video but if network conditions are moderate or poor, high-resolution performance audio is delivered after DAW timeline transport has stopped, and the system is in band meeting mode.

In some embodiments, if the system is being used for a live performance, the value of having high-resolution audio for subsequent post production is high. In other embodiments, if the system is being used for a multi-track studio production, the high-resolution audio may be inserted into the host DAW between takes, for further evaluation and editing.

Turning to FIG. 4, a method of synchronizing collaborators is shown. In one embodiment, the method of FIG. 4 provides an embodiment of a method to more accurately synchronize multiple audio and video data streams (or musician inputs) over the Internet. This may allow for a seamless user experience for each collaborator to collaborate on a production in a creative studio environment without the need for multiple applications and sub-optimal technologies.

As outlined above, one problem that the current disclosure addresses is to provide improved synchronization between collaborators that are connected to the system via a public network (Internet) connection. In one embodiment, the system corrects each collaborator's (or musician's) clock by continually synchronizing the collaborator's input (via the timeslot value or offset) with respect to a unique local clock on the collaborator device and resolving that with a system-based digital clock offset (based on the clock provided by the clock module 114f). This may also allow for application messages to be precisely scheduled at a future time, relative to the distance of the collaborator device from the server or system.

In one embodiment, the disclosure creates sample-based timeslot offsets for each stage of synchronization and therefore allows for low-latency intercommunication between collaborators. The timeslot assignments allow the musicians to collaborate and perform with a seamless “real-time” experience.

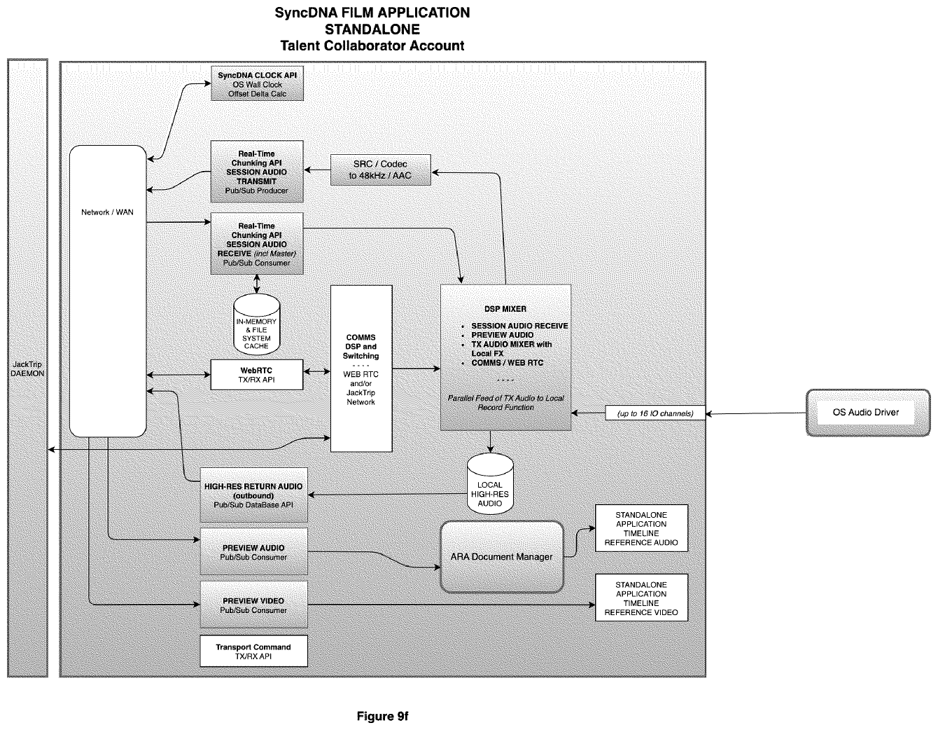

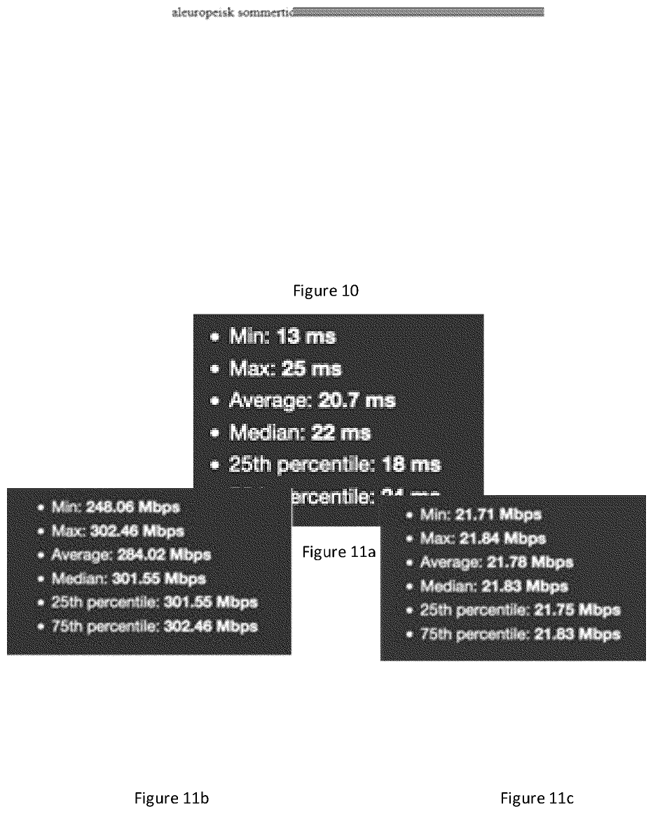

Initially, the system determines a round-trip time (RTT) for each of the collaborators or musicians that are collaborating with the system (400). The RTT may be defined as an amount of time required for a message to be transmitted from the system to the collaborator device and then back to the system (or server that stores the system). In one embodiment, the RTT may be calculated by performing a high-intensity individual time packet calculation (approximately 50 time packets/s) during an initial handshake period between the collaborator device and the system or server. An average determination of how long it takes each of the approximately 50 individual time packets to be returned to the system from the collaborator device is then calculated and set as the average RTT or RTT for the collaborator. An example calculation is shown in FIG. 11a which shows that the over the approximately 50 individual time packets, the minimum RTT was 13 ms, the maximum RTT was 25 ms, the average RTT was 20.7 ms and the median RTT was 22 ms. During (400), the server may also perform a speed test with each collaborator or musician collaborator to determine if an optimal, or pre-determined, bandwidth can be maintained. Examples of test results for the speed test determination are schematically shown in FIGS. 11b and 11c.

Once the initial average RTT values for each collaborator is set, the system may continue to calculate a rolling average for each collaborator based on their RTT by continuously transmitting individual time packets to the collaborator device. This may occur even when the collaborator is transmitting input to the system. By continuously transmitting individual time packets, the system is able to monitor the characteristics of the connection between an individual collaborator device and the system as the connection between the device and the system may be unreliable over the public network.

The system may also include a module that includes artificial intelligence (AI) such as in the form of a learning algorithm or neural network and the like to generate a calculation of the delay variable or a SysClock/PTP correction variable.

A lob delay for each musician is then calculated (402). The lob delay may be seen as an amount of time the system should artificially delay the dispatch of an individual time packet based on the average RTT for the collaborator calculated in (400). In one embodiment, individual time packets are transmitted to the individual collaborators whereby each corresponding time packet should arrive at each collaborator device at the same time based on the lob delay in order to synchronize the transmission between the system and all of the collaborators.

In one embodiment, the lob delay for the set of collaborators may be calculated as outlined below. For simplicity, it is assumed that the set of musician collaborators is represented as C={c1, c2, . . . , ci, . . . , cN} where there are N collaborators. The set of collaborator RTTs is represented as RTT={rtt1, rtt2, . . . , rtti, . . . , rttN} where rtti is collaborator ci's RTT and the lob delay for each collaborator ci is represented as Idi=(max(RTT)−rtti)/2.

The system then applies the lob delay for each collaborator connection (404). In one embodiment, the clock module within the system maintains an internal stream of ticks (which may represent an internal clock counter system) which is piped or transmitted through an artificial delay mechanism which applies the lob delay for each collaborator's connection before dispatching individual time packets toward each collaborator device. In some embodiments, the system transmits the individual time packets to an application that is stored on the collaborator device for studio session use. In further embodiments, the application that communicates with the clock module may be stored within middleware of the collaborator device. This may be seen as clock synchronization between all the collaborators and the clock module of the system. By using such this clock synchronization mechanism, actions taken by a collaborator can be scheduled to occur at a specified moment in the future in order to enable synchronization of the inputs between the collaborators.

The clock module functionality may be implemented as a multi-tenant system-side application in conjunction with a collaborator-side application programming interface (API). The system-side application continually monitors the connection with each connected collaborator, such as via a learning algorithm, that pulls heuristics from each collaborator connection and generates a rolling average ½ RTT to adjust each collaborator to the clock generated or associated with the clock module.

As the collaborators continue to supply the audio/video inputs, the server continues to monitor each connection's latency and jitter, or connection characteristics (406). In one embodiment, the server continues to calculate, adjust and monitor a musician's latency and jitter in real-time. The collaborator-server connection with the most prolonged or a highest latency is set as a “default” priority for the timeslot calculation and buffer values and locked into the system timeslot variables each time the system rolls. An example of the clock client that may be displayed is shown in FIG. 10

FIG. 5a shows an example of inputs received by a system that does not provide synchronization for the asynchronous inputs while FIG. 5b shows a method of synchronizing inputs in accordance with an embodiment of the disclosure. As shown in FIG. 5b, when a collaborator authenticates and signs in to the system, their userID is assigned a “radius” or collaborator radius or RTT value (measured in milliseconds/samples) which may then be stored in the database as part of a session. The assignment of radius values enables the system to determine which collaborator has the highest radius or RTT value. Based on this, the system then sets timeslot table values and audio/video chunk sizes accordingly while adding appropriate margins for each collaborator. In some embodiments, the collaborator radius may be seen as attribute that represents a combination of RTT and a time buffer. Each collaborator's radius parameter is updated with low granularity (approximately every 30 seconds) based on ongoing calculations from the clock module and ongoing pings. The width of time between any of the timeslots can be wider or narrower, based on the group of connected collaborators assembled in that particular timeslot assignment, and is adjusted dynamically throughout the session. Each time the timeline transport rolls, the system uses the timeslot and chunk size values from the session database. These settings are fixed until the next time the timeline transport is stopped, although calculations to monitor radius values continue as a background process while rolling.

As can be seen in the example of FIG. 5b, the system 500 is connected to a set of collaborators such as, but not limited to, a first producer (seen as digital audio workstation (DAW) 502), a band leader 504 (Artist A), a set of band members 506 including five (5) artists (Artist B; Artist C; Artist D; Artist E and Artist F) where artist C 508 has a highest radius among the Band collaborators; a second producer DAW 502 which receives unpredictable inputs from an Artist G and a set of couch positions 510 seen as Studio Couch A and Studio Couch B.

For this example, the first producer DAW has a radius of 300 ms; Artist A has a radius of 360 ms; Artist B has a radius of 280 ms; Artist C has a radius of 800 ms; Artist D has a radius of 402 ms; Artist E has a radius of 244 ms; Artist F has a radius of 520 ms; Studio Couch A has a radius of 260 ms and Studio Couch B has a radius of 492 ms.

It is reasonable to assume that a radius of 250 miles from the JackTrip server will allow for sub-25 ms latency, and allow for reasonable rehearsal and musical exchange prior to synchronized performance and recording.

As more clearly shown in FIG. 5b, the determination of timeslots for each of the collaborators based on the radius calculations provides the synchronization between the collaborators. The timeslot for a collaborator (or grouping of collaborators) can be calculated as a sum of the largest radius from two different collaborator groupings along with a buffer value. The buffer value may be predetermined, may be based on a percentage of the radius values or may be automatically selected by the system. For the current example, the buffer value has been selected as 100 ms.

In one example of determining timeslots using the example radius values of FIG. 5b, since the producer has a radius of 300 ms and the Leader (Artist A) has a radius of 360 ms, the timeslot value for the leader can be calculated based on the total of the two individual radius values and the buffer value which is 760 ms. This means that when the action is taken to start the timeline transport, Leader A hears audio or sees video 760 ms after the timeline transport is started.

Between the Leader (Artist A) and the Band (Artists B to F), since Artist C has the largest radius, the timeslot value for the Band can be calculated as the sum of 360 ms (Leader A)+800 ms (Artist C)+100 ms (buffer value) which means that the timeslot value for the Band is 1260 ms. This means that when the action is taken to start the timeline transport, each of the collaborators in the Band grouping hears audio or sees video 1260 ms after the Leader hears the audio or sees the video which is 2020 ms after timeline transport is started.

The timeslot value between the Band and the Producer can be calculated as the sum of the largest radius for the Band members (800 ms for Artist C)+Producer radius (300 ms)+buffer value (100 ms) for a timeslot value of 1200 ms. Since the producer typically performs the action to start the timeline transport, the timeslot value for the producer represents the time that the producers hears input that is generated by the Leader and/or the Band after the timeline transport is started. While the timeslot is 1200 ms, the producer hears the input 3220 ms after the transport timeline has been started.

Finally, the timeslot value between the producer and the couch can be seen as the sum of the producer radius (300 ms)+largest radius of a couch collaborator (492 mms for Guest B)+buffer value (100 ms) for a timeslot value of 892 ms. This means that the guests will hear an input 4112 ms after the timeline transport has been started. As such, this provides the synchronization between the collaborators. The timeslot determinations delay the transmission and receipt of inputs for the collaborators grouping such that they hear input at the same time.

Whether the timeline transport is rolling or stopped, the system continues to transmit individual time packets to the collaborators to continuously update their radius values so that updated timeslots can be dynamically and continuously determined.

After the timeline transport is restarted, when it is stopped again, the system retrieves the current timeslot values such that input transmission is synchronized such as described above. In one embodiment, when the action is taken to start the timeline transport, inputs are transmitted between the collaborators and the system. The timeslot offset is then applied to the input and the input is played for the collaborator after the offset has elapsed in order to synchronize the playing of inputs.

In one embodiment of operation, the system toggles between two main modes of operation which may be represented as a “meeting mode” and a “rolling mode”. The meeting mode may be seen as a mode where collaborators are meeting or performing without any synchronization while the rolling mode may be seen as a mode where the host DAW is rolling and there is ongoing synchronization required for the recording of audio/video or playback of audio/video between the collaborators.

For the meeting mode (such as using WebRTC), when a collaborator signs in to the system, the collaborator can navigate to join the audio/video conference in standard WebRTC audio and video. As long as the host DAW timeline transport is stopped, and whenever it returns to a “Stop” condition, the system will be in “meeting mode.” This may be seen as a basic audio/video conference where no synchronization is required.

If the collaborator's connection does not meet a minimum-defined or predetermined latency and bandwidth conditions (whereby a radius value is higher than a predetermined value), the collaborator will be muted to other live performers (or collaborators) when the system is in the “rolling mode”. This is due to the fact that the collaborator's audio latency will likely be too great for any meaningful rehearsal in “meeting mode” but is acceptable for communication and one-way performance of ideas, etc. Their synchronized session audio will, of course, be passed along to the next timeslot(s).

In other embodiments of the disclosure, the system may determine which connected collaborators have connections with the system that are suitable for interaction. For example, if a meeting mode with a COMMS rehearsal mode enabled is being used, if the system determines that the collaborator (based on at least one of a qualifying network connection bandwidth, a suitable RTT, a suitable radius and/or suitable individual time packet return times as determined by the system) is able to connect to a low-latency COMMS bus, their connection with the system will be marked as “rehearsal ready” by the system such that it is recorded in the database. In other embodiments, the system may transmit a message to the collaborator device indicating that the collaborator has been designated “rehearsal ready. In one embodiment, the disclosure uses the CCRMA—Stanford.edu-developed open source “JackTrip” server for this purpose, although other systems are contemplated.

During rolling mode, performances (in the form of audio/video streams) from each “rehearsal ready” collaborator is interconnected with or available to other “rehearsal ready” or “qualified” collaborators in their same timeslot, allowing for reasonable interplay during both system conditions. When the system timeline transport is stopped, the system switches automatically to the COMMS/Band meeting mode at the lowest possible latency.

In one specific method of operation, when the system is in a rolling mode (which may represent a record and playback mode), in order to start the transmission of synchronized audio and video through the system, an operator (who may be seen as a producer) of the system initiates a timeline transport “record” command which is transmitted to all connected collaborator devices. The “record” command provides instructions to the collaborator (or the collaborator device) to start or initiate local timeline transport, recording or transmission) of the musical input from the collaborator device to the system at a specified delta-timeline-samples location. In one embodiment, this may be approximately 300-400 ms ahead depending on an overall system latency variable with respect to time-of-day of the clock module. This system variable may be referred to as a Transport Command Offset (“TCO”). For example, “if current system Time-of-Day is 13:24:16.000, at system Time-of-Day 13:24:16.400, roll timeline at 1248000 (00:00:26.000)”

At this time, all connected collaborator devices begin rolling whereby all audio and video data chunks generated on each collaborator device are embedded with timestamps, associated with the collaborator device system clock; a channel ID, a client ID, and encryption, etc.

Once the system is rolling, each collaborator device operates on its own internal digital clock and ignores the dynamically adjusting system clock (the one generated by the clock module) until the timeline transport is stopped again. If the differential between the system clock server time and the collaborator device's clock time is greater than 20 ms, or becomes greater than 20 ms on average, the system generates or turns on an unlock Indicator for the collaborator. When this occurs, the system continues to roll and recording continues without interruption.

During recording, the system timestamps each audio and video chunk (received from a collaborator connected device) based on their location on the application timeline and on delta-samples calculated from 0-samples on the DAW timeline. In one embodiment, audio chunks could be small (from 1600 samples at 48 kHz which is equal to 1 frame of video at 30 fps) or larger (as high as 2000 ms or more). Based on the calculation of delta-timeline offsets, system offset variables (sample-based) can be set or assigned by the system to set exact time-slot locations for each stage of audio transmission buffer/synch. “Playback” mode operates the synchronization aspects of the system similarly, except that on playback, the system streams the locally stored audio that arrived in chunks (now concatenated) and streams the audio.

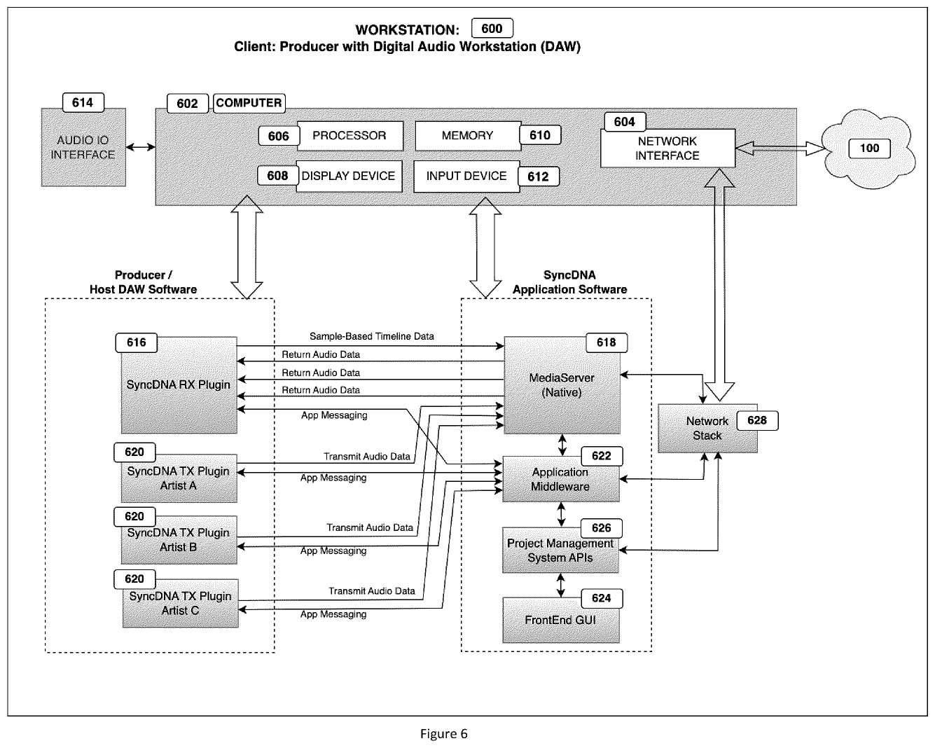

Turning to FIG. 6, a schematic diagram of one embodiment of a DAW is shown. The DAW of FIG. 6 may be the collaborator device 106 that is used by the producer in FIG. 1. The DAW 600 includes a computer component 602 that includes a network interface 604 enabling the DAW 600 to communicate with the system 100. The computer component 602 may further include a processor 606 for processing any inputs from users and for controlling other components of the DAW. The computer component may further include a display device 608, memory 610, such as in the form of a database, and an input device 612. In some embodiments, the DAW 101 may also include an audio I/O interface 614.

Stored within the DAW 600 are modules implemented via hardware, software or firmware or a combination of hardware, software and/or firmware, may perform, or assist to perform, the functionality to interact with the system to provide the method of the disclosure.

These modules include, but are not limited to, a system or session RX (receiver) plugin 616 that provides the functionality to send sample-based timeline data from the DAW 600 to a MediaServer module or component 618. In use, each collaborator's real-time audio (both low-resolution and high resolution) is segmented into chunks and published into a publisher/subscriber topic assigned for that channel. Low-resolution chunks are prioritized, but both are pulled as system and network resources allow from the corresponding artist collaborator's topic into the producer standalone applications, cued in sequence for exact sample-accurate playback for the audio stream arriving at the receive plugin. The modules may also include a set of system or session TX (transmitter) plugins 620 (which in the current embodiment is one for each collaborator) that enables the DAW 600 (or the user associated with the DAW 600) to send audio to other collaborators in the session.

The collaborators can either receive real-time audio from their associated TX plugin 620 when the system is being used in “DAW Leader” mode or “performer leader” mode. The producer can also send live cue mixes out to each collaborator in their associated performance timeslots and audio chunks are played locally at their exact sample-based time (either low-resolution or high-resolution, depending on network conditions). When the system is being used in “overdub” mode, the reference audio chunks for collaborators are sent offline in advance and are stored locally for playback. Collaborators in the couch time slot receive live audio transmission whereby the audio chunks arriving at the couch time slot are treated as ephemeral, and discarded after timeline transport has stopped. The MediaServer module 618 also receives the sample-based DAW timeline data from the local host DAW software application running inside the same OS environment. This enables the producer collaborator to control the timeline transport for all connected collaborators, including scrubbing back and forth across the timeline—reflected in every connected collaborator's application. The MediaServer module 618 may also be responsible for all of the audio data flowing into, and out of the system from each collaborator. In one embodiment, all of the sample-accurate audio and video recording, playback, track & take management, etc., may be performed or managed by the MediaServer module 618. The MediaServer module 618 may also connect directly to host network access, and manage all of the media data traffic between itself, cloud services, and local file system.

The set of modules may further include a system application middleware module or component 622. This component 622 may communicate directly with the MediaServer module 618 and runs, or executes, all of the application programming interfaces (APIs) outside of MediaServer module 618. The application middleware module 622 also communicates with the communication module. Another module may be seen as a front-end GUI component 624 that controls and displays all data and information associated with middleware component 622. The front end GUI component 624 may also combine all of the unique and innovative controls and GUI design elements that allow the collaborator to control complex system modes with simple drag-and-drop controls for timeslot assignments, audio and video hardware controls, scheduling, community platform, and film audio post workflow GUI.

Another software module may be a set of system project management APIs 626. The APIs 626 provide another unique aspect to the system of the disclosure. When a project management feature flag is engaged, collaborators may enter timeline-based markers based on event input from the GUI 624, and automatically create location-based tasks and notes in one simple operation. A further software module may be seen as a network connection module or component 628 which enables the MediaServer module 618 and the application middleware module 622 to connect to Network Cloud Backend Services, or system 100 via the host workstation's OS network stack 628.

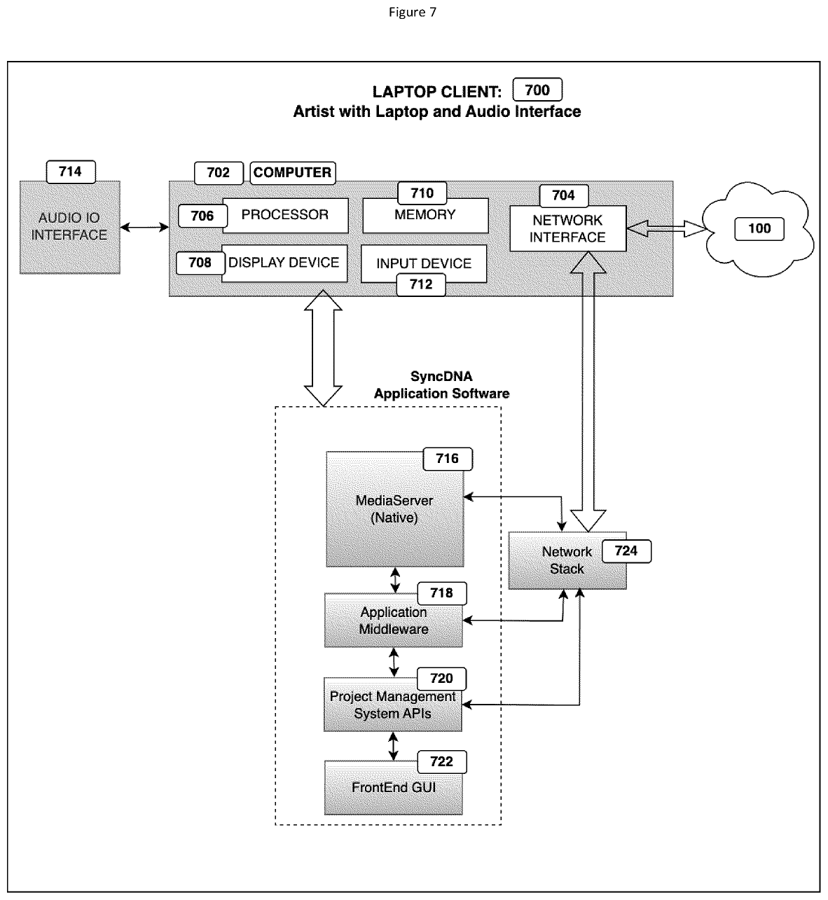

Turning to FIG. 7, a schematic diagram of a collaborator device is shown. The collaborator device 700 of FIG. 7 may represent one of the collaborator devices 108 of FIG. 1.

The collaborator device 700 includes a computer component 702 that is similar to the computer component 602 of FIG. 6. The computer component 702 includes a network interface 704 that enables the collaborator device 700 to communicate with the system 100. The computer and an audio I/O interface 714. In the current embodiment, the computer component 702 further includes a processor 706, or processing unit, a display device 708, memory 710 and an input device 712.

The user communication device 700 includes a set of modules that provide the functionality to communicate with the system to assist in providing a virtual studio environment. The set of modules may be implemented via software, hardware or firmware or a combination thereof. In the current embodiment, the set of modules may be associated with the system and may be part of the system in some embodiments.

The set of modules may include a MediaServer module 716, an application middleware module or component 718, a project management system APIs component 720, a front end GUI component 722 and a network stack component 724. These components may perform the same functionality as discussed above with respect to the DAW workstation 600 but are native to the collaborator device 700.

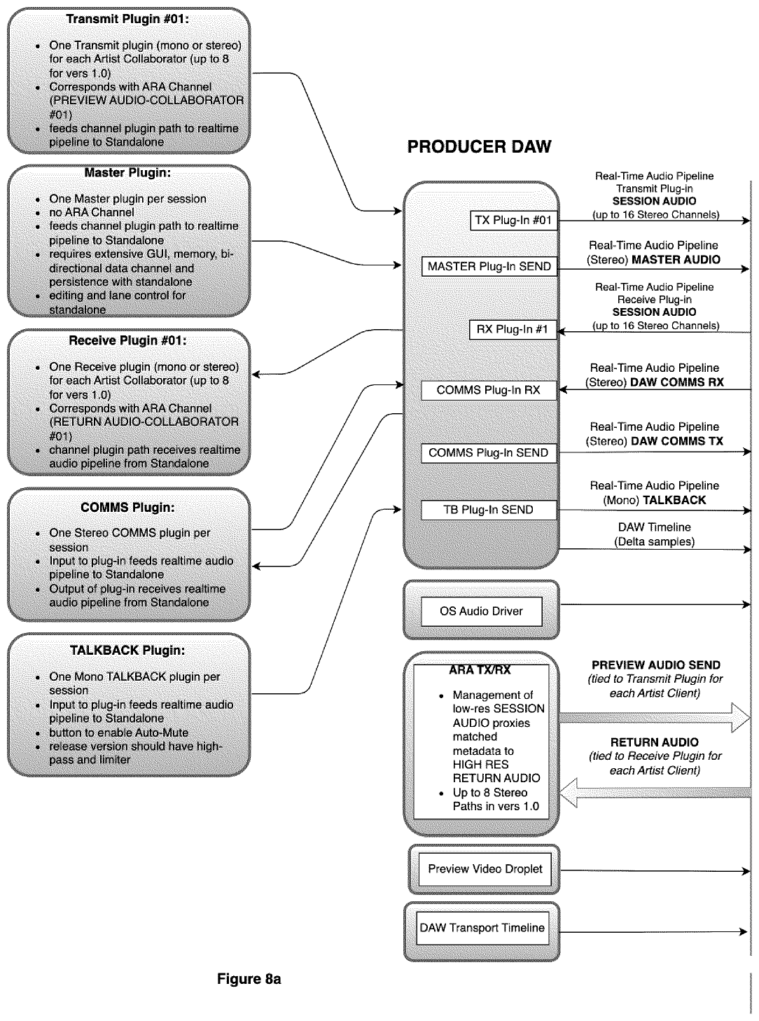

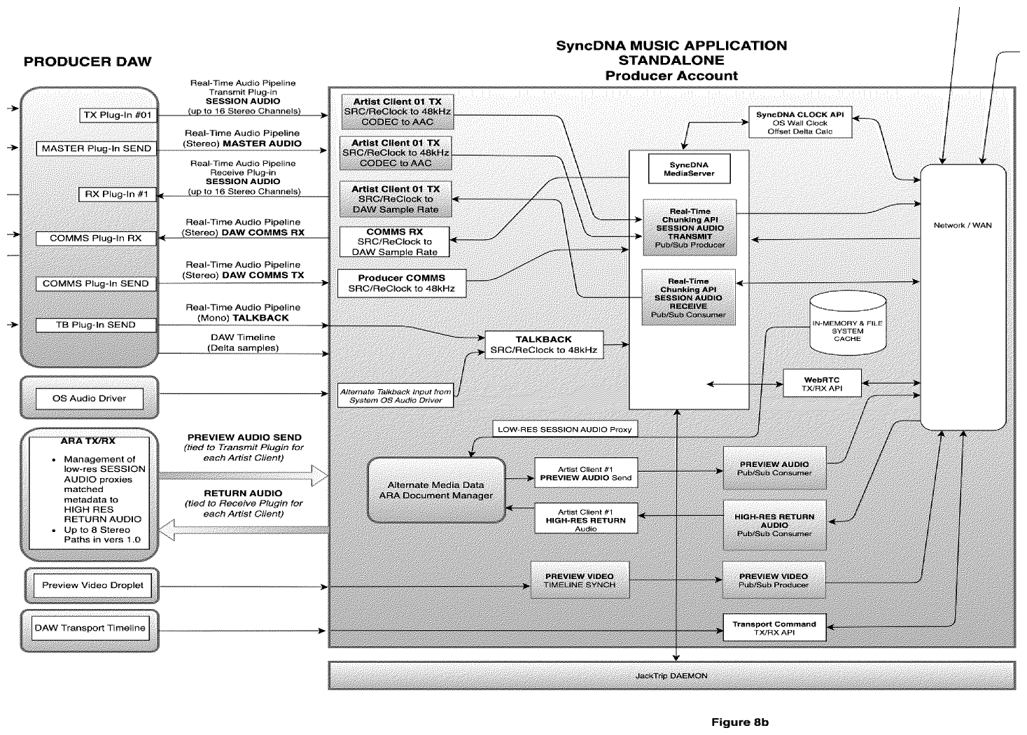

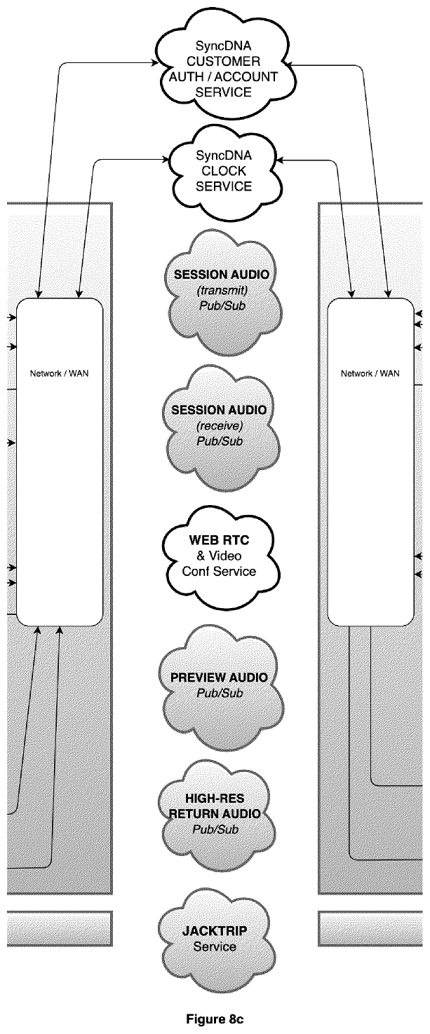

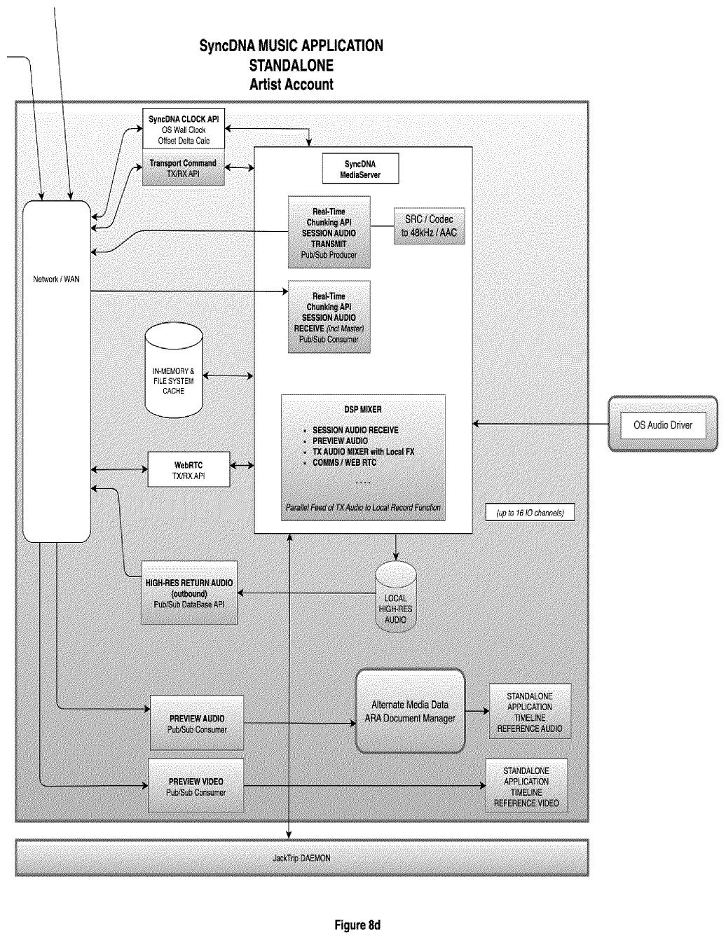

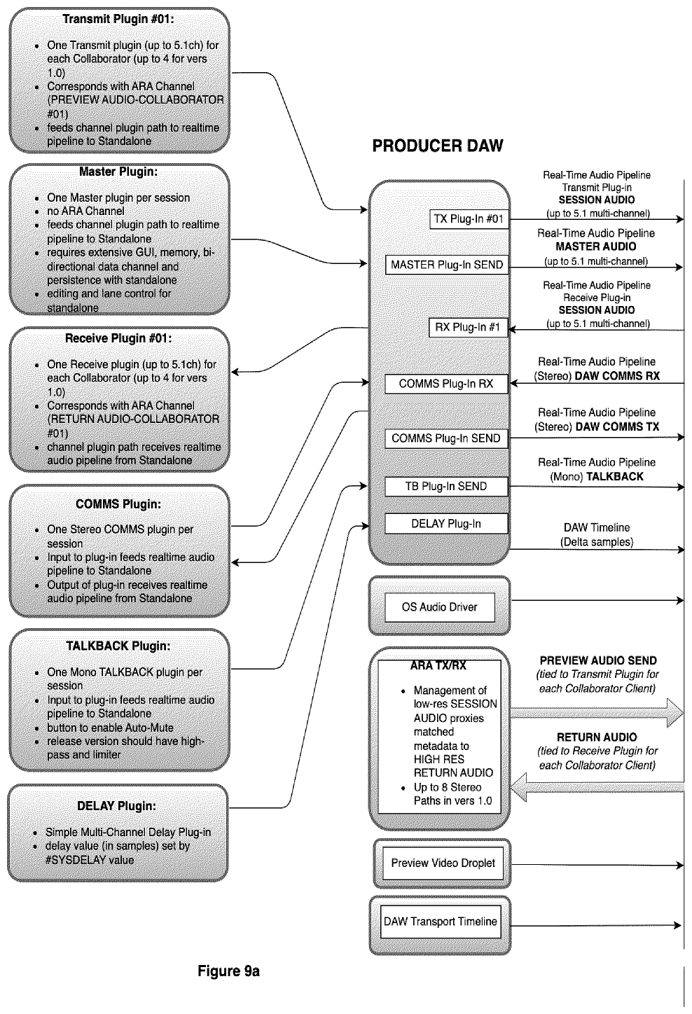

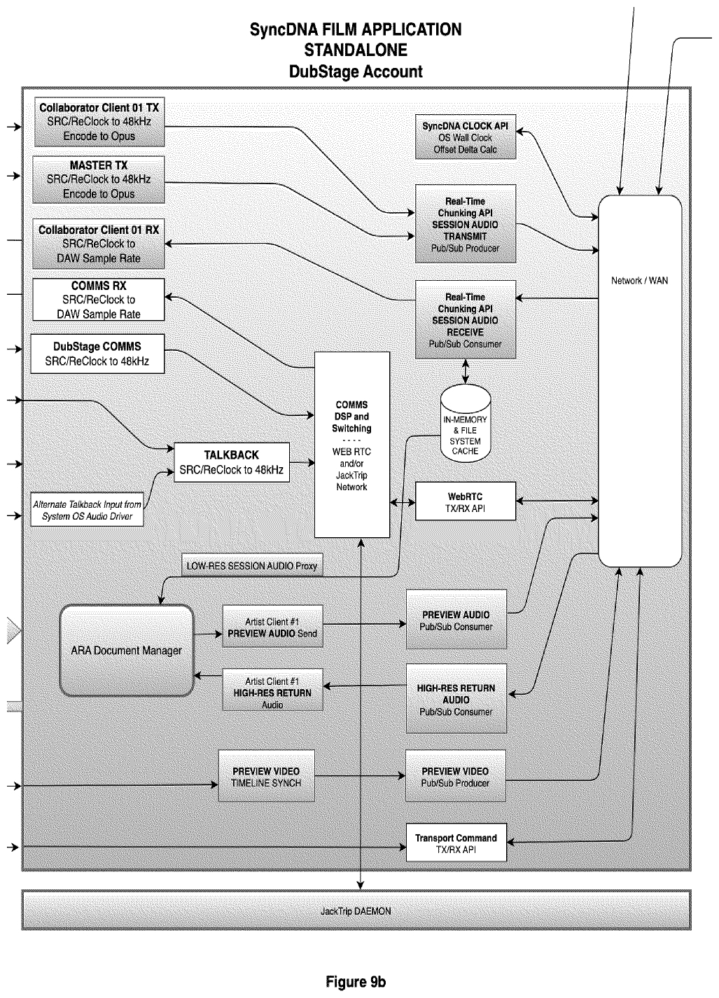

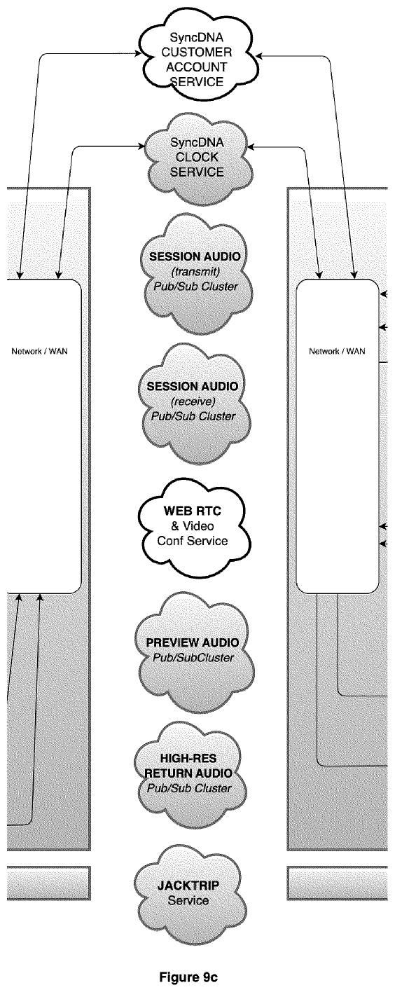

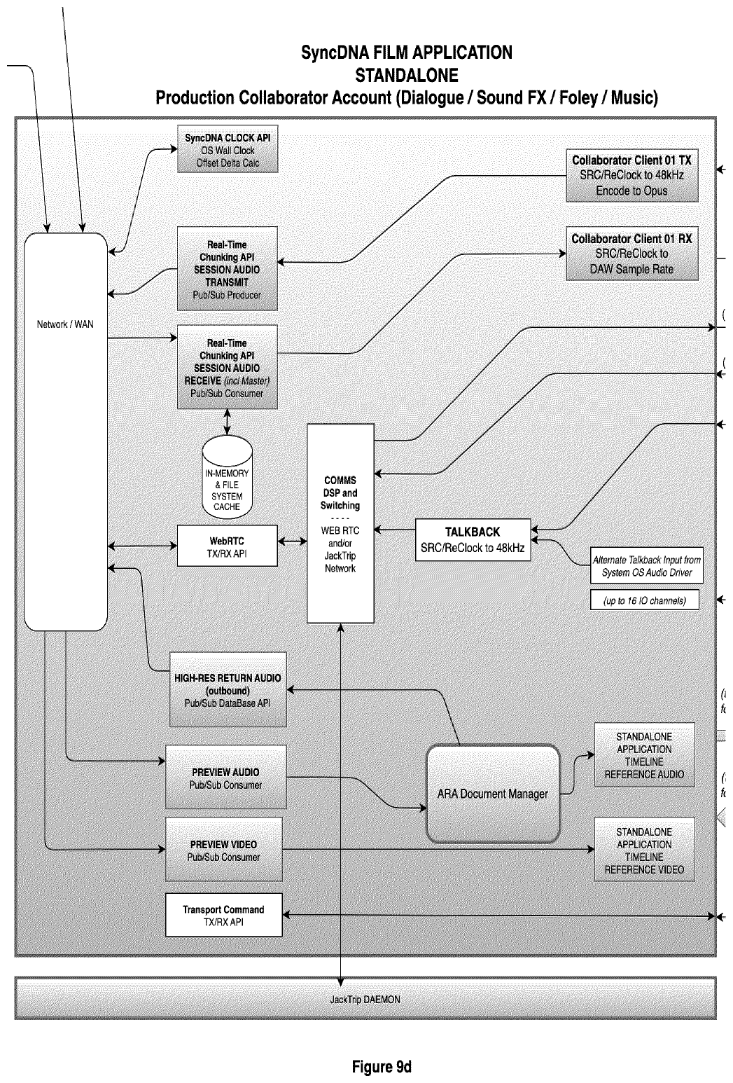

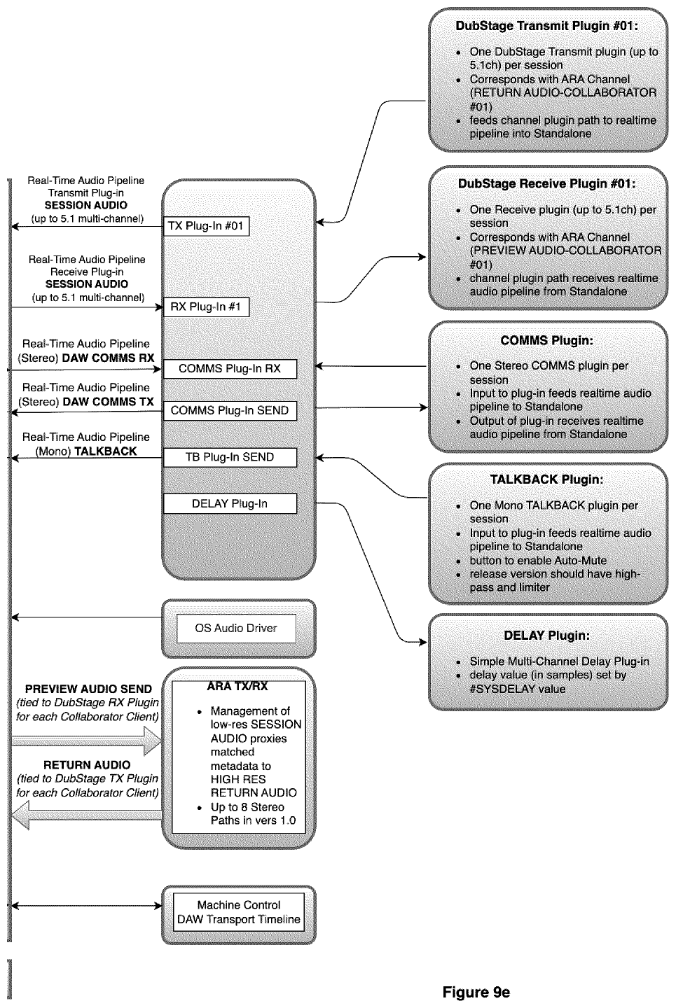

FIGS. 8a to 8d are directed at a schematic diagram of one aspect of the system architecture. FIGS. 9a to 9f are directed at a schematic diagram of another aspect of the system architecture.

In other embodiments, the disclosure may be used in other industries such as, but not limited to, remote music recording over the Internet; film audio post-production where collaboration and synchronization may be enabled through a DAW-to-DAW connectivity network or via a remote location to home-base and vice-versa set-up; media broadcasting to stream and replay synchronized content to media and other connected clients; broadcast interview synchronization to reduce or eliminate transmission lag and awkwardness when a reporter interviews a person experiencing transmission signal delay; podcast and videocast with multiple participants; live concerts with performers collaborating from anywhere in the world; songwriting/composing sessions over the Internet; band rehearsals over the Internet; delay compensation “plug-in” modules for mixer or editing desks to monitor local files through a synchronized delay for each channel; gaming and VR media and data synchronization with multiple participants collaborating from remote locations in real-time; masterclass education, including groups of students or educators collaborating or teaching with one or more of the participants over the Internet; corporate presentations with synchronized participants in multiple locations; synchronization and/recording of video or audio meetings of multiple participants to assist in communicating during the editing of documents or other materials; synchronization of internet based customer support communications, where chat rooms, live audio and onscreen items such as assembly instructions can be synchronized real time; interactive broadcast with interactive second screen functionality for interactive TV broadcast, live performance broadcast or sports broadcast; augmented/virtual reality/metaverse with immersive audio support for transmission of synchronized multichannel audio and video; facility to facility collaboration (Audio Post Team Collaboration);

The disclosure may also provide the functionality to perform at least one of the following: update and edit media files that automatically synchronize real-time through the Internet from DAW-to-DAW, allowing multiple users to edit a master version of the content in real-time; virtual review & approval over the Internet for performance and recording with immersive audio and Dolby audio support; rendering synchronized files for spatial audio and Dolby audio technology; be used as platform for purchase, deployment or operation of spatial audio and Dolby audio technology modules, as well as other 3rd party software sound enhancement or effect modules; be used as a platform for purchase, deployment or operation of company owned software sound enhancement technology or related effect modules, such as, but not limited to, compressors, reverb, modulation and echo/delay effects.

Other opportunities include, but are not limited to, empowering social media and virtual meeting participants to successfully sing songs together over the internet, such as “Happy Birthday” to a family member; video movie “Watch Party” synchronization with high precision; synchronization of multiple wireless headphones; karaoke interaction over the internet with one or more participants; karaoke performances with streaming media; gaming applications where audio or video can synchronize more readily or enhance player performance; role playing gaming applications where audio and video can synchronize more readily to enhance team collaboration and interaction of participants; security applications where multi-campus facilities can transmit sample-accurate audio and frame-accurate video for precise logging of footage; security applications where audio or video files (or potentially other content) can be “shredded” for storage or delivery and later reassembled automatically into sample accurate files; systems to synchronize, monitor and track sensors for IoT (Internet of Things) devices; enhance the security or encryption of media files that can be sent over the internet, including messaging platforms; use with 3rd party data encryption tools to secure integrity of media files or other potentially content; use for subdividing media files or potentially other content when attempting large file transfers, to support several smaller files in transfer process and later reassembly; use with BitTorrent client software applications to support efficient and secure peer-to-peer (P2P) file sharing stand alone or with third party systems such as the BitTorrent Protocol; use with 3rd party Blockchain software applications; use with decentralized Blockchain technology, including applications that utilize a digital ledger for embedding or piecing together content; uses of embedded metadata in the media content to identify and ensure session information, performer rights and data sovereignty; ensure the creative publishing process can be better recorded and recreated at a later date should the users have a legal reason to do so; uses of metadata, file version control, synchronization timing and other attributes that are additive in eDiscovery related legal searches; synchronize files real-time content from DAW to cloud service hyperscalers such as Amazon™, Microsoft™ Azure™ and Google™ for data storage, including accurate back up and recovery of files; synchronize files real-time content from DAW to on-premise computer servers such as IBM or others, for data storage, including accurate back up and recovery of files; synchronization of sub-title technology to audio and video during the creation and editing process and/or precise synchronization of multiple Bluetooth or network-connected speaker playback systems.

In some specific embodiments, with respect to audio/video file metadata in the rolling mode, the MediaServer module or component on each connected collaborator's device executes on its timeline transport adjusted sample-based clock, and audio/video data captured by each connected collaborator system (capture of the music or sounds played by the musician) is sliced into data chunks and written to memory. In some embodiments, the data chunks may be written to a storage medium such as, but not limited to, a disk. In one embodiment, these may be saved as high-resolution linear pulse code modulation (PCM) and matching Ogg Vorbis-encoded compressed file “chunks”. Each of these “chunks” may then be embedded with auth/JWT, channelID, userID and sample-based (and in the case of video, Frame-based) timestamps, and other important metadata related to the session.

When the timeline transport is stopped, the MediaServer modules retrieve the remaining high-resolution chunks from the publisher/subscriber back end system, and once it has confirmed that all of them are present, runs a concatenation script to create a full-length flat file (AES31-Broadcast WAV), stored on the producer's local file system. Once written to disk, the files are then made available in the RX plugin user interface where the producer can drag them onto the DAW timeline (or use 3rd party scripting application to place them there automatically).

In some specific embodiments, with respect to the MediaServer module or each collaborator device, at the heart of the system of DAW Plug-Ins is the RX (Receiver) plugin. Every session requires that the producer use a host DAW. The RX plugin provides the sample-based DAW timeline data to the MediaServer module which runs natively outside of the host DAW in the OS environment. This allows the producer to control the timeline transport of the system application for all connected collaborators (clients), including scrubbing back and forth across the timeline.

In some specific embodiments, the different modules (Music, Film and/or Broadcast) within the system may use a group of publisher/subscriber database broker clusters to manage the different types of data in the system such as via SQL/MongoDB, Pub/Sub Messaging-oriented Middleware such as Redis, ActiveMQ, Kafka, Akka, etc. For the real-time audio, each application writes to a single time-series database, which is initially stored locally. When recording, it breaks the data stream into chunks, which are inserted into a topic document in binary form, along with metadata markings such as session ID, client ID, channel ID, precision timestamp and cryptographic metadata/authentication/JWT. In the background, each of these “documents” (chunks) are replicated to the server-based broker cluster. From there, data is then pulled from the subscriber path, assembled in sequence, and played out of the MediaServer module using the timestamps and segment ID numbers to reassemble the audio stream in sample-accurate synch with the DAW timeline (with appropriate offsets).

In some specific embodiments, with respect to a preview audio and preview video mode, when the system is being used in “Reference” (or “Overdub”) mode, the host Producer account can send preview audio and optional video out to each artist collaborator. The preview audio is selected on the track timeline for each collaborator in the host/producer DAW, and pushed out to the standalone application offline via TX Plugin process. For preview video, the system allows for one reference video file per session—viewable and common to all collaborators that have video permissions selected and enabled. The video file may be ingested into the producer DAW via a droplet, chunked and distributed to permitted users, adjusted for positioning in the standalone application—and synchronized via the MediaServer module and the a video player on each connected collaborator's system.

In some specific embodiments, with respect to session audio TX—from the producer DAW to collaborator devices, when the system is being used in “DAW Leader” mode or “Performer Leader” mode, the host producer can send live cue mixes out to each collaborator in their associated performance time-slots and audio chunks are played locally at their exact sample-based time (either low-resolution or high-resolution, depending on network conditions). These audio chunks are treated as ephemeral, and discarded after timeline transport has stopped. When the system is being used in “overdub” mode, the reference audio chunks for performers are sent offline, in advance (as shown below) and are stored locally for playback.

In some specific embodiments, with respect to master plug-in TX, when real-time audio derived from a TX Plugin on the producer's DAW, master fader is ‘chunked’ by the local MediaServer module and published for all participants assigned to the studio couch timeslot, these audio chunks are received and played at the DAW timeline value plus the couch timeslot value.

With respect to a session audio RX—from an artist collaborator to producer DAW, each collaborator's real-time audio (both low-resolution and high-resolution) is likewise ‘chunked’ and published into the publisher/subscriber topic assigned for that channel. Low-resolution chunks are prioritized, but both are pulled as system and network resources allow from the corresponding artist collaborator's topic into the producer DAW, cued in sequence for exact sample-accurate playback for the audio stream arriving at the receive plug-in.

In some specific embodiments, with respect to low-resolution and high-resolution return audio, the audio chunks stored in memory and/or written into a local folder on each collaborator's device are embedded with metadata including client ID, channel ID, precision timestamp, file hash and encryption keys, etc. When the system is idle and/or when background resources network bandwidth are available, the high-resolution audio chunks are published into their corresponding topics, and pulled into the producer DAW, where the files are then written to disk and take priority over the low-resolution proxy files. Similarly to real-time mode, on playback, the received audio is cued and played in real time synch with the host DAW timeline through the RX plug-in. Once all high-resolution chunks have arrived, the concatenated audio files can be committed to DAW tracks via the RX plugin file manager. This unique system of synchronized audio transfer between the system and the collaborator devices is an advantage of the current disclosure.

In some specific embodiments, with respect to unique timeslot delay compensation plug-in, among the different plug-ins, the delay plugin provides a simple way to precisely align the local DAW playback audio with the incoming live audio from remote artists or collaborators with sample accuracy. The plug-in has no user GUI but merely needs to exist in the audio path of local DAW playback audio and gets its delay value from the system directly, and dynamically adjusts depending on the system mode. The delay plug-in may also be used in a review & approval session where the local DAW audio monitoring can be delayed so that the producer is hearing the audio at the same time as the collaborators on the couch time-slot. This unique method of delay compensation takes a very complex matrix of information and simplifies the user experience substantially.

In some specific embodiments, with respect to system protocol, the system combines a set of advanced methods for sample-accurate audio and frame-accurate video synchronization.

In some specific embodiments, with respect to metadata, the system protocol injects metadata strings into each data chunk as it leaves the application. Audio data transmission settings are flexible but initially set to 1600 samples (at 48 kHz). Each transmission block corresponds to one frame of video at 30 fps, although the size of each transmission block will vary for each sample and frame rates.

The metadata may include labels or data such as OrganizationID, ProjectID, SessionID, ClientID, DAW BPM/BAR/TICK, Track ID, Date and Timestamp, macros, system timecode string, and encryption keys, among others.

In some specific embodiments, with respect to timeslot synchronization protocol, one feature of the system architecture is the precisely defined time-slot offsets at each stage of the system, allowing for asynchronous TCP/IP transmission of audio and video data, rather than UDP/WebSocket data stream. It can be understood as a real-time incremental upload and download of audio and video data (‘chunking’), rather than a “stream.” Therefore, there is ample time for transmission retries for missing data chunks, and AI interpolation of missing data if retries fail.

An advantage of the system is that a one-hour audio file transmitted via the system will play for precisely one hour. The playtime of an audio file transmitted via UDP/WebSocket streaming can vary considerably.

In some specific embodiments, with respect to a system timeslot offset system, one principle behind the synchronized audio and video data moving through the system is the determination of exact offsets between designated time-slots. In the widest configuration of the system, the system includes five time-slot offset nodes (with three performance time-slots). In this example, for simplicity, offsets are shown with fixed values—although, in operation, the calculation of each time-slot is based on heuristics from the system clock module. In order to cue and synchronize the audio and video data to each time slot, the offsets must be calculated and fixed each time the system enters “rolling record” mode.

In some specific embodiments, with respect to a timeslot designation system, in one embodiment, the assignment of time-slots is done by the master account holder (the producer account) using an innovative drag-and-drop GUI system where the operator can move participants to whichever timeslot is desired. Another advantage of the system is that collaborators are designated as a “local artist” (performing in the same facility as the producer), as a “remote artist” as indicated by an antennae graphic, or in the listen-only time-slot “Studio Couch”. By simplifying the complex time-slot, assignments into these simple and self-explanatory matrix assignments, it's clear to the user how the system has been configured and easy to change settings during regular use.

In some specific embodiments, with respect to audio/video timing offset and dataflow, the system design leverages its unique simplified user GUI to manipulate a series of complex system conditions determined by many factors. When the producer drags a participant icon into a particular time slot, and designates them as either “local” or “remote” artist, the system can determine the timeslot offset (or delay variable/arrival time) calculation for that user, so that the communication module or application stored within the collaborator device is buffering and synching the arriving audio chunks to play at precisely the correct sample-accurate location on the application timeline, depending on which time-slot location they have been assigned to. Likewise, the new audio created by the participant makes its way back to the producer system, and the real-time ‘Session Audio’ is buffered and synched to playback at the precise timeline location set for the producer DAW. When the timeline transport is stopped, and the producer decides to play back a performance, the arriving audio chunks (now concatenated) stored in a single flat file in the local folder, is shifted back to playback at the proper timeline location based on the file's metadata timestamp.

Another embodiment of the timeslot offset system allows for any number of virtual timeslots to be created between the DAW/leader/band/producer/couch timeslots by way of running an instance of the application middleware module and MediaServer module in the cloud-based virtual machine, whereby the incoming media streams from multiple locations are synchronized and then re-transmitted as a unified media feed to a performer in another remote location and their performance (Audio & Video media) is delivered to the subsequent timeslots.

In some specific embodiments, with respect to media security, because of the underlying system design whereby all audio and video data is transmitted through the system as individual ‘chunks’ (rather than complete files) each secured by their own unique keys, the effective result is that even if the media data was intercepted en-route, it would be the equivalent to receiving a truckload of cross-cut paper shreddings, and trying to reassemble them. Major media production companies with guidance from MPAA (Motion Picture Association of America) have taken great pains to implement stringent media management strategies with production facilities, composers, sound designers, editors, etc., to ensure that media, networks, and file transmissions are as secure as possible.

In some specific embodiments, with respect to user profile integration with session track template & project management, another unique aspect of the System is the deep integration of the user database/community platform, with audio track templates and project management system. When a collaborator creates their profile, they can also create a set of named track inputs connected to their audio interface. This allows a producer that has invited them to a recording session to be able to pull those track attributes from each performer into the current session so that all of the tracks and corresponding files are pre-labelled and ready to drag into the host DAW session. Therefore, a producer can create timeline-based markers, instant messages, or tasks in the feature-rich integrated project management system.

In some specific embodiments, with respect to innovative user experience for artist collaborators, the system provides a frictionless experience whereby the entire operation of the recording process and system is up to the producer collaborator. The entire process of creating tracks, starting and stopping the timeline transport, shared controls for monitoring, etc., leave the artist collaborators free to concentrate on performing, and spend less time managing the recording process.

In some specific experiments, the system has been successful over long distances involving multi-channel, sample-accurate audio with multiple performers in multiple locations. The system was successful in transmitting at least 16 channels (9.1.6) of immersive sample-accurate audio over the public internet with robust and consistent professional-level performance (including timecode lock), with only network conditions as upper-end track limitations. The system was also successfully tested using multi-channel immersive audio (9.1.6) from producer-to-artist and rendering live to Apple™ Spatial Audio, including head-tracking for any application that requires the synchronization of audio and video feeds and simple and highly effective method of transmitting audio and video to cloud-based back-end broadcast distribution for live events

In one aspect, there is provided a method for real-time, sample-accurate synchronization of audio, and fame-accurate synchronization of video (image, graphics, text, etc.) over the elastic and unreliable Internet. In another aspect, there is provided a method for manipulating precise time offsets—synchronization of application clients and media objects to the exact same time axis at different geographical locations.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed:

1. A method for synchronizing inputs received over the Internet from a set of a collaborator devices comprising:
transmitting a set of individual timing packets to each of the set of collaborator devices;
determining a round trip time (RTT) value for each of the set of collaborator devices based on the set of individual timing packets;
calculating a collaborator radius value for each of the set of collaborator devices based on the RTT value; and
calculating a timeslot offset value based on the collaborator radius value for each of the set of collaborator devices.

2. The method of claim 1 further comprising:
applying the timeslot offset to a transmission of data with each of the collaborator devices.

3. The method of claim 2 wherein applying the timeslot offset occurs after an action is taken to start timeslot transport.

4. The method of claim 3 further comprising calculating an updated timeslot offset value by:
transmitting an updated set of individual timing packets to each of the set of collaborator devices;
determining an updated RTT value for each of the set of collaborator devices based on the updated set of individual timing packets;
calculating an updated collaborator radius value for each of the set of collaborator devices based on the updated RTT value; and
calculating the updated timeslot offset value based on the updated collaborator radius value for each of the set of collaborator devices.

5. The method of claim 1 wherein determining a RTT value comprises:
determining a time period between transmitting one of the set of individual time packets to a selected collaborator device and receiving a returned individual time packet, from the selected collaborator device;
wherein the returned individual time packet is based on the one of the set of individual time packets.

6. The method of claim 1 wherein calculating a timeslot offset value based on the collaborator radius value for each of the set of collaborator devices comprises:
adding a first collaborator radius value to a second collaborator radius value to generate; and
applying a buffer value to a sum of the first collaborator radius value and the second collaborator radius value.

7. The method of claim 6 wherein the first collaborator radius value is selected as a highest collaborator radius value within a first grouping of collaborator devices.

8. The method of claim 7 wherein the second collaborator radius value is selected as a highest collaborator radius value within a second grouping of collaborator devices.

9. The method of claim 1 wherein the set of collaborator devices comprises at least one of a producer digital audio workstation, a non-linear video editing system; a musician collaborator device, an artist collaborator device or a guest collaborator device.

10. The method of claim 1 wherein transmitting a set of individual timing packets to each of the set of collaborator devices comprises:
transmitting the set of individual timing packets to an application associated with the system that is executing on the collaborator device.

11. The method of claim 10 wherein the set of individual timing packets is transmitted via a clock system module.

12. The method of claim 1 further comprising, before, transmitting a set of individual timing packets to each of the set of collaborator devices:
authenticating each of the set of collaborator devices.

13. A non-transitory computer readable medium having instructions stored thereon that, when executed, cause at least one computer system to:
transmit a set of individual timing packets to each of the set of collaborator devices;
determine a round trip time (RTT) value for each of the set of collaborator devices based on the set of individual timing packets;
calculate a collaborator radius value for each of the set of collaborator devices based on the RTT value; and
calculate a timeslot offset value based on the collaborator radius value for each of the set of collaborator devices.
